(19) United States
(12) Patent Application Publication
(10) Pub. No.: US 2016/0125271 A1
(43) Pub. Date: May 5, 2016

(54) FEATURE AMOUNT CONVERSION APPARATUS, LEARNING APPARATUS, RECOGNITION APPARATUS, AND FEATURE AMOUNT CONVERSION PROGRAM PRODUCT

(71) Applicant: DENSO CORPORATION, Kariya-city, Aichi-pref. (JP)

(72) Inventors: Mitsuru Ambai, Shibuya-ku (JP); Mikio Shimizu, Kariya-city (JP)

(21) Appl. No.: 14/895,198

(22) PCT Filed: May 28, 2014
(86) PCT No.: PCT/JP2014/002816

§ 371 Date: Dec. 1, 2015

(30) Foreign Application Priority Data
Jun. 3, 2013 (JP) 2013-116918
Feb. 18, 2014 (JP) 2014-028980

(51) Int. Cl. G06K 9/62; G06T 7/60; G06K 9/46; G06K 9/52

(52) U.S. Cl. CPC G06K 9/6262; G06K 9/52; G06T 7/60; G06K 9/4642; G06T 2200/28; G06T 2207/20081

(57) ABSTRACT

A feature amount conversion apparatus includes a plurality of bit rearrangement units, a plurality of logical operation units, and a feature integration unit. The bit rearrangement units generate rearranged bit strings by rearranging elements of an inputted binary feature vector into diverse arrangements. The logical operation units generate logically-operated bit strings by performing a logical operation on the inputted feature vector and each of the rearranged bit strings. The feature integration unit generates a nonlinearly converted feature vector by integrating the generated logically-operated bit strings.

### CROSS REFERENCE TO RELATED APPLICATION

The present disclosure is based on Japanese Patent Application No. 2013-116918 filed on Jun. 3, 2013 and Japanese Patent Application No. 2014-28980 filed on Feb. 18, 2014, the disclosures of which are incorporated herein by reference.

### TECHNICAL FIELD

The present disclosure relates to a feature amount conversion apparatus that converts a feature amount used for recognition of a target. The present disclosure also relates to a learning apparatus and a recognition apparatus that include the feature amount conversion apparatus, and to a feature amount conversion program product.

### BACKGROUND ART

There is conventionally commercialized a recognition apparatus that recognizes a target through machine learning, in various fields such as image search, voice recognition, and text search. Such recognition extracts a feature amount from information, e.g., image, voice, or text. When a particular target is recognized from an image, a HOG (Histograms of Oriented Gradients) feature amount may be used as an image feature amount (refer, e.g., to Non-Patent Literature 1). A feature amount is handled in the form of a feature vector, permitting a computer to easily handle. The information, such as image, voice, or text, is namely converted to a feature vector for target recognition purposes.

The recognition apparatus recognizes a target by applying a feature vector to a recognition model. A recognition model for a linear discriminator is given, e.g., by Formula (1).

f(x)=w^{T}x+b (1)

where x is a feature vector, w is a weight vector, and b is a bias. The linear discriminator performs a binary classification depending on whether f(x) is greater or smaller than zero when the feature vector x is given.

This recognition model is determined through a learning using many feature vectors prepared for learning purposes. The above linear discriminator uses, as learning data, many positive examples and negative examples to determine the weight vector w and the bias b. An SVM (Support Vector Machine)-based learning method may be adopted as a concrete example.

The linear discriminator is particularly useful due to its rapid calculations in learning and discrimination. However, the linear discriminator can achieve linear discrimination (binary classification) only, therefore exhibiting a disadvantage failing to provide a high discrimination capability. This leads to an attempt to improve a feature amount description capability by subjecting a feature amount to nonlinear conversion in advance, for instance, by using co-occurrence of feature amounts. This corresponds to a FIND (Feature Interaction Descriptor) feature amount (refer, e.g., to Non-Patent Literature 2).

The FIND feature amount provides an improved feature amount discrimination capability by calculating the harmonic mean of all combinations of elements of a feature vector to obtain co-occurring elements. More specifically, when a d-dimensional feature vector x=(x₁, x₂, . . . , x_{D})^{T} is given, nonlinear calculations are performed on all combinations of the elements as indicated by Equation (2).

yᵢⱼ=xᵢyⱼ/(xᵢ+yⱼ) (2)

Herein, the FIND feature amount is given by y=(y₁₁, y₁₂, . . . , y_{DD})^{T}.

When the feature vector x is, e.g., 32-dimensional, the FIND feature amount is 528-dimensional excluding overlapping combinations. If necessary, y may be normalized until its length is 1.

### PRIOR ART LITERATURES

### Non-Patent Literature

Non-Patent Literature 1: Navneet Dalal and Bill Triggs, “Histograms of Oriented Gradients for Human Detection”, CVPR '05 Proceedings of the 2005 IEEE Computer Society Conference on Computer Vision and Pattern Recognition (CVPR'05)—Volume 1—Volume 01, Pages 886-893
Non-Patent Literature 2: Hui CAO, Koichiro YAMAGUCHI, Mitsuhiko OHTA, Takashi NAITO, and Yoshiki NINOMIYA, “Feature Interaction Descriptor for Pedestrian Detection”, IEICE TRANSACTIONS on Information and Systems Vol. E93-D No. 9 pp. 2656-2659

### SUMMARY OF INVENTION

Determining the FIND feature amount, however, needs calculations of all combinations of the elements of the feature vector. The amount of such calculations is in the order of the square of the number of dimensions. Further, the calculations are extremely slow because a division operation needs to calculate each element. Moreover, the number of dimensions of the feature amount is large, involving the increase in the amount of memory consumption.

The present disclosure has been made in view of the above circumstances. An object of the present disclosure is to provide a feature amount conversion apparatus that rapidly performs nonlinear conversion on a feature amount when the feature amount is binary.

Another object of the present disclosure is to provide a feature amount conversion apparatus that converts a feature vector to a binary value even when the feature amount is not binary.

A feature amount conversion apparatus according to a first example of the present disclosure includes a bit rearrangement portion, a logical operation portion, and a feature integration portion. The bit rearrangement portion generates a plurality of rearranged bit strings by rearranging elements of an inputted binary feature vector into diverse arrangements. The logical operation portion generates a plurality of logically-operated bit strings by performing a logical operation on the inputted feature vector and each of the rearranged bit strings. The feature integration portion generates a nonlinearly converted feature vector by integrating the generated logically-operated bit strings. This configuration calculates co-occurring elements of the inputted feature vector by rearranging the inputted feature vector and performing a logical operation. Therefore, the co-occurring elements can be rapidly computed.

The feature integration portion may further integrate the elements of the inputted feature vector as well as the generated logically-operated bit strings. This configuration additionally uses the elements of an original feature vector. Therefore, a nonlinearly converted feature vector having a high description capability can be obtained without increasing a computation amount.

The logical operation portion may calculate the exclusive OR of the rearranged bit strings and the inputted feature vector. The exclusive OR is equivalent to the harmonic mean. The probability of occurrence of “+1” is equal to the probability of occurrence of “−1”; this configuration can calculate co-occurring elements having a high feature description capability comparable to the feature description capability of FIND.

The bit rearrangement portion may generate the rearranged bit strings by performing a rotate shift operation with no carry on the elements of the inputted feature vector. This configuration can efficiently calculate co-occurring elements having a high feature description capability.

The feature amount conversion apparatus may include d/2 bit rearrangement portions when the inputted feature vector is d-dimensional. Under this configuration, each of a plurality of the bit rearrangement portions performs a bit shift by one bit to provide a rotate shift operation with no carry, enabling the plurality of the bit rearrangement portions to generate all combinations of the elements of the inputted feature vector.

The bit rearrangement portion may randomly rearrange the elements of the inputted feature vector. This configuration can also calculate co-occurring elements having a high feature description capability.

The feature amount conversion apparatus may include a plurality of binarization portions and a plurality of co-occurring element generation portions. Each binarization portion may generate the binary feature vector by binarizing an inputted real number feature vector. The co-occurring element generation portions may correspond to the respective binarization portions. The co-occurring element generation portions may each include the plurality of the bit rearrangement portions and the plurality of the logical operation portions. The binary feature vector may be inputted to the co-occurring element generation portions from the corresponding binarization portions. The feature integration portion may generate the nonlinearly converted feature vector by integrating all the logically-operated bit strings generated respectively by the plurality of the logical operation portions in each of the co-occurring element generation portions. This configuration can rapidly acquire a binary feature vector having a high feature description capability even when the elements of the feature vector are real numbers.

The binary feature vector may be acquired by binarizing a HOG feature amount.

The feature amount conversion apparatus according to a second example of the present disclosure includes a bit rearrangement portion, a logical operation portion, and a feature integration portion. The bit rearrangement portion generates a rearranged bit string by rearranging elements of an inputted binary feature vector. The logical operation portion generates a logically-operated bit string by performing a logical operation on the rearranged bit string and the inputted feature vector. The feature integration portion generates a nonlinearly converted feature vector by integrating the elements of the feature vector and the generated logically-operated bit string. This configuration also calculates co-occurring elements of the inputted feature vector by rearranging the inputted feature vector and performing a logical operation. Therefore, the co-occurring elements can be rapidly computed.

The feature amount conversion apparatus according to a third example of the present disclosure includes a plurality of bit rearrangement portions, a logical operation portion, and a feature integration portion. The bit rearrangement portions generate a rearranged bit string by rearranging elements of an inputted binary feature vector into diverse arrangements. The logical operation portion generates logically-operated bit strings by performing a logical operation on the rearranged bit strings generated by the bit rearrangement portions. The feature integration portion generates a nonlinearly converted feature vector by integrating the elements of the feature vector and the generated logically-operated bit strings. This configuration also calculates co-occurring elements of the inputted feature vector by rearranging the inputted feature vector and performing a logical operation. Therefore, the co-occurring elements can be rapidly computed.

The feature amount conversion apparatus according to a fourth example of the present disclosure includes a plurality of bit rearrangement portions, a plurality of logical operation portions, and a feature integration portion. The bit rearrangement portions generate a rearranged bit string by rearranging elements of an inputted binary feature vector into diverse arrangements. The logical operation portions generate logically-operated bit strings by performing a logical operation on the rearranged bit strings generated by the bit rearrangement portions. The feature integration portion generates a nonlinearly converted feature vector by integrating the generated logically-operated bit strings. This configuration also calculates co-occurring elements of the inputted feature vector by rearranging the inputted feature vector and performing a logical operation. Therefore, the co-occurring elements can be rapidly computed.

A learning apparatus according to another example of the present disclosure includes a feature amount conversion apparatus according to any one of the foregoing examples of the present disclosure and a learning portion. The learning portion achieves learning by using the nonlinearly converted feature vector generated by the feature amount conversion apparatus. This configuration also calculates co-occurring elements of an inputted feature vector by rearranging the inputted feature vector and performing a logical operation. Therefore, the co-occurring elements can be rapidly computed.

A recognition apparatus according to yet another example of the present disclosure includes a feature amount conversion apparatus according to any one of the foregoing examples of the present disclosure and a recognition portion. The recognition portion achieves recognition by using the nonlinearly converted feature vector generated by the feature amount conversion apparatus. This configuration also calculates co-occurring elements of an inputted feature vector by rearranging the inputted feature vector and performing a logical operation. Therefore, the co-occurring elements can be rapidly computed.

The recognition portion in the above recognition apparatus may calculate the inner product of a weight vector in the recognition and the nonlinearly converted feature vector in the order of the largest distribution to the smallest or in the order of the highest entropy value to the lowest, and may terminate the calculation of the inner product when the inner product is determined to be greater or smaller than a predetermined threshold value for recognition. This configuration can rapidly perform a recognition process.

A feature amount conversion program product according to still another example of the present disclosure includes instructions causing a computer to function as a plurality of bit rearrangement portions, as a plurality of logical operation portions, and as a feature integration portion, and is recorded on a computer-readable, non-transitory medium. The bit rearrangement portions generate a rearranged bit string by rearranging elements of an inputted binary feature vector into diverse arrangements. The logical operation portions generate logically-operated bit strings by performing a logical operation on the inputted feature vector and the rearranged bit strings. The feature integration portion generates a nonlinearly converted feature vector by integrating the generated logically-operated bit strings. This configuration also calculates co-occurring elements of the inputted feature vector by rearranging the inputted feature vector and performing a logical operation. Therefore, the co-occurring elements can be rapidly computed.

The above configurations calculate co-occurring elements of an inputted feature vector by rearranging the inputted feature vector and performing a logical operation. Consequently, the co-occurring elements can be rapidly computed.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating exemplary elements of a binary feature vector in a first embodiment of the present disclosure;

FIG. 2 is a diagram illustrating XOR-to-harmonic mean correspondence in the first embodiment;

FIG. 3 is a diagram illustrating the XOR of all combinations of elements of the binary feature vector in the first embodiment;

FIG. 4 is a diagram illustrating a process of calculating co-occurring elements by performing a rotate shift operation with no carry in the first embodiment;

FIG. 5 is a diagram illustrating the XOR of all combinations of the elements of the binary feature vector in the first embodiment;

FIG. 6 is a diagram illustrating a process of calculating co-occurring elements by performing a rotate shift operation with no carry in the first embodiment;

FIG. 7 is a diagram illustrating the XOR of all combinations of the elements of the binary feature vector in the first embodiment;

FIG. 8 is a diagram illustrating a process of calculating co-occurring elements by performing a rotate shift operation with no carry in the first embodiment;

FIG. 9 is a diagram illustrating the XOR of all combinations of the elements of the binary feature vector in the first embodiment;

FIG. 10 is a diagram illustrating a process of calculating co-occurring elements by performing a rotate shift operation with no carry in the first embodiment;

FIG. 11 is a diagram illustrating the XOR of all combinations of the elements of the binary feature vector in the first embodiment;

FIG. 12 is a diagram illustrating a configuration of a feature amount conversion apparatus according to the first embodiment;

FIG. 13 is a diagram illustrating a HOG feature amount of one block of image in a second embodiment of the present disclosure and the result obtained by binarizing the HOG feature amount;

FIG. 14 is a diagram illustrating how a feature description capability is enhanced by a multiple threshold value in the second embodiment;

FIG. 15 is a diagram illustrating a feature amount conversion in the second embodiment;

FIG. 16 is a block diagram illustrating a configuration of the feature amount conversion apparatus according to the second embodiment;

FIG. 17 illustrates program codes of a comparative example;

FIG. 18 illustrates program codes of an exemplary embodiment; and

FIG. 19 is a graph illustrating erroneous detection-to-detection rate correspondence prevailing when a recognition model generated by learning is recognized by a recognition apparatus.

### DESCRIPTION OF EMBODIMENTS

Embodiments of a feature amount conversion apparatus according to the present disclosure will now be described with reference to the accompanying drawings. The embodiments described below are intended to be illustrative only. The present disclosure is not limited to specific configurations described below. When the present disclosure is to be implemented, any specific configurations may be adopted as appropriate depending on an embodiment of the present disclosure.

### First Embodiment

When a feature vector, which is a binary HOG feature amount, is given, the feature amount conversion apparatus according to a first embodiment of the present disclosure performs nonlinear conversion on the feature vector (hereinafter, referred to as “nonlinearly converted feature vector”) to obtain a feature vector having an improved discrimination capability. If, for instance, an area formed by 8 pixels×8 pixels as one unit is defined as a cell, a HOG feature amount is obtained as a 32-dimensional vector for each block formed by 2×2 cells. In this first embodiment, it is assumed that the HOG feature amount is obtained as a binarized vector. A principle of determining a nonlinearly converted feature vector having co-occurring elements comparable to those of FIND by performing nonlinear conversion on a binary feature vector will be described before describing a configuration of the feature amount conversion apparatus according to the present embodiment.

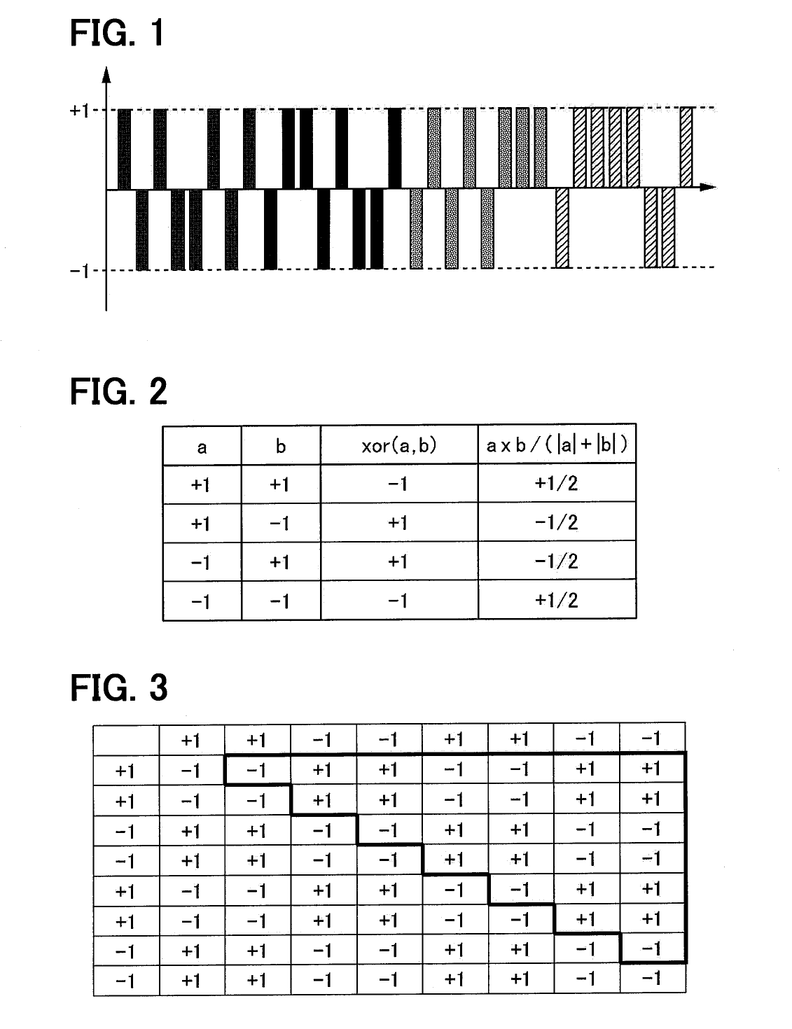

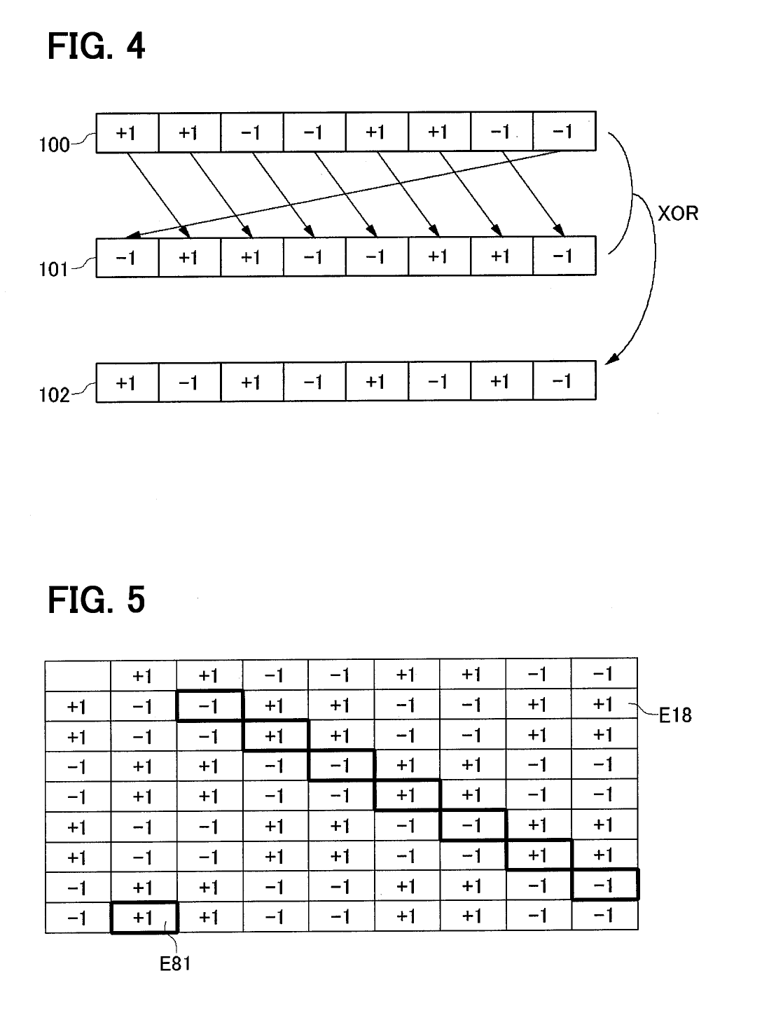

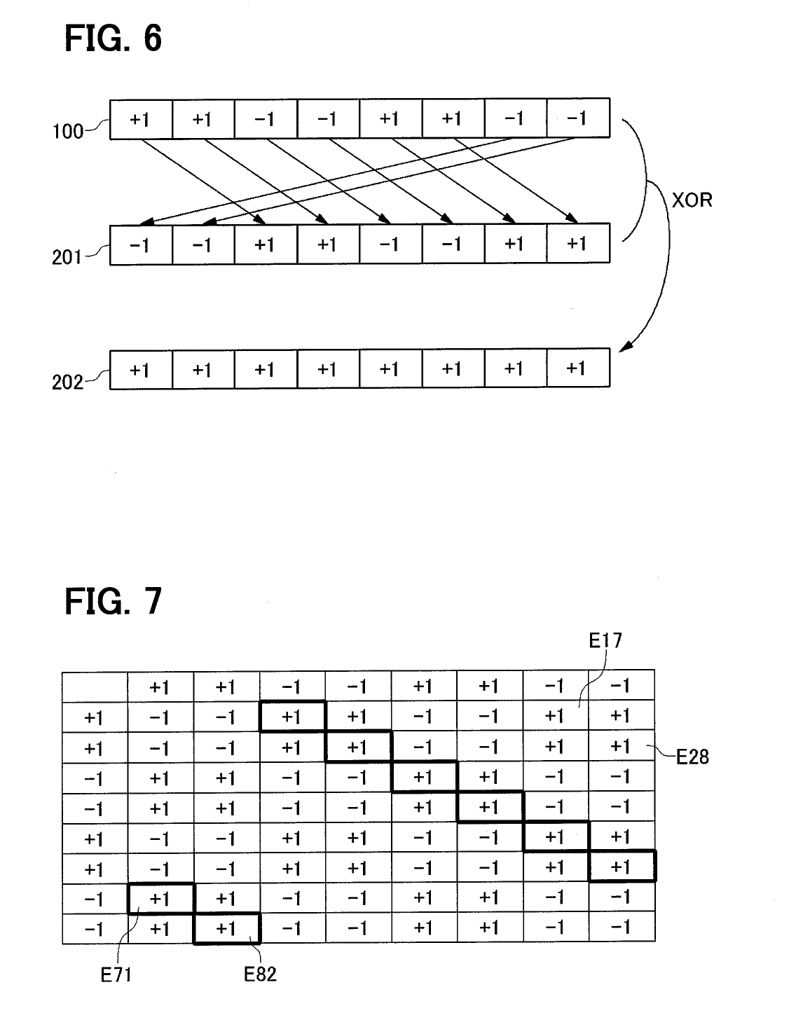

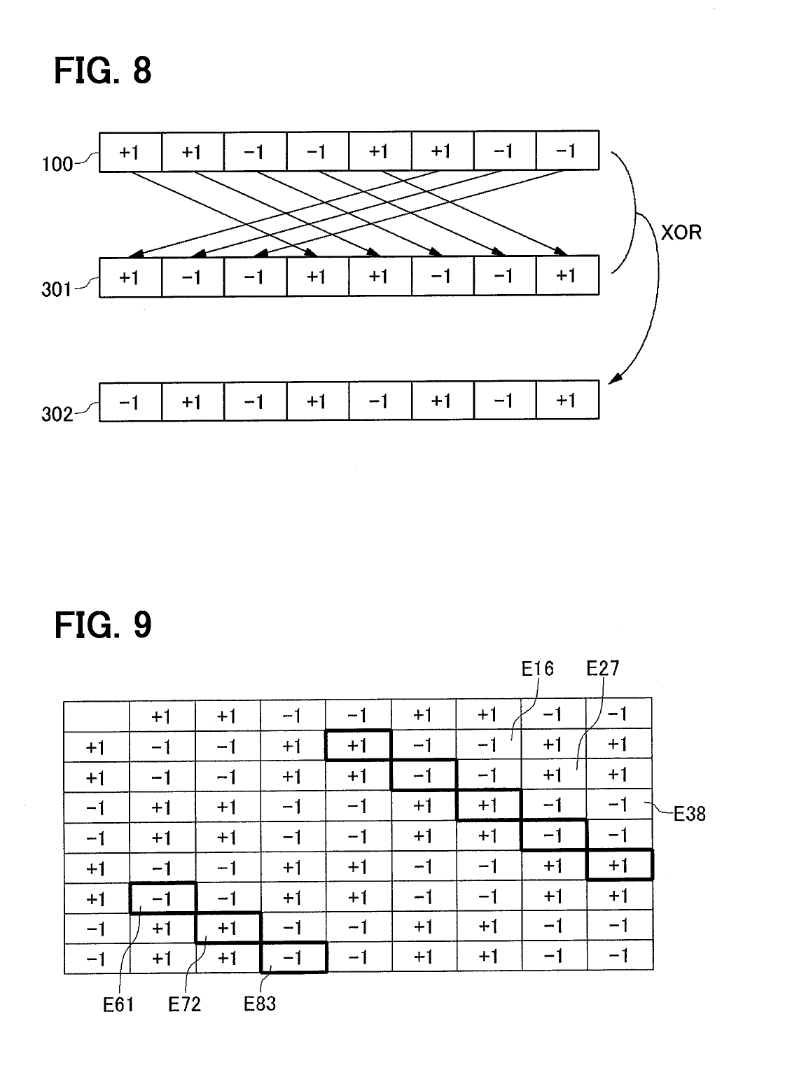

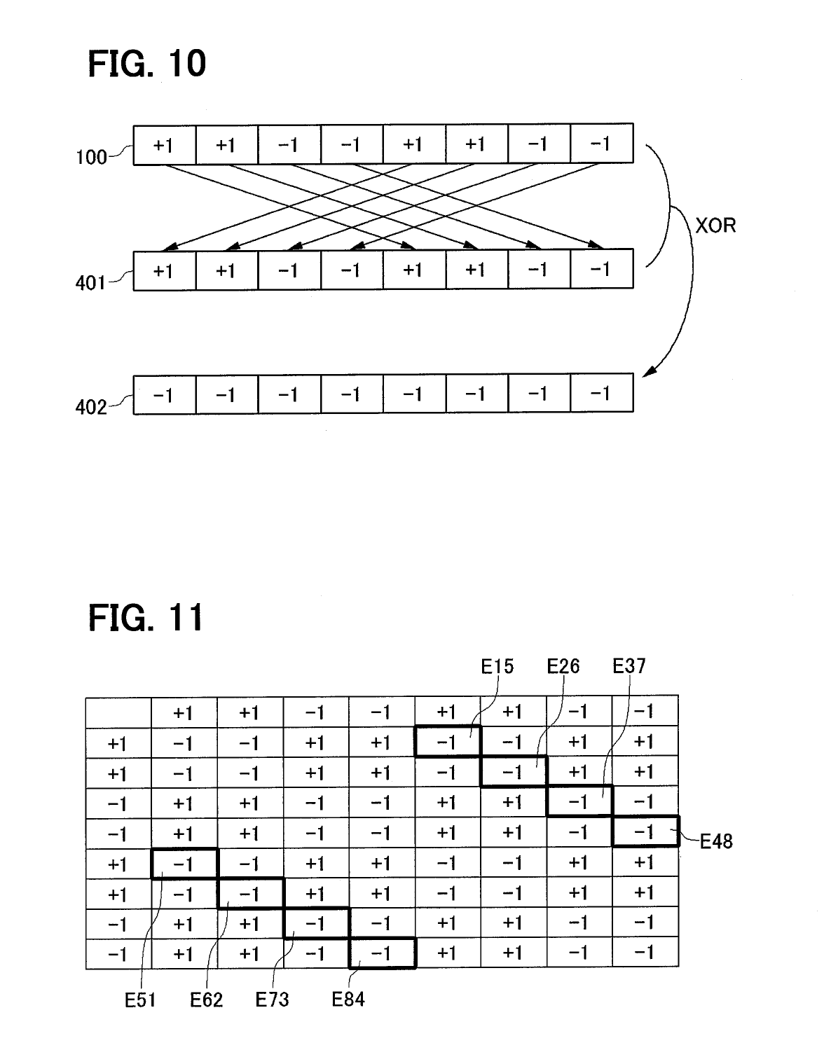

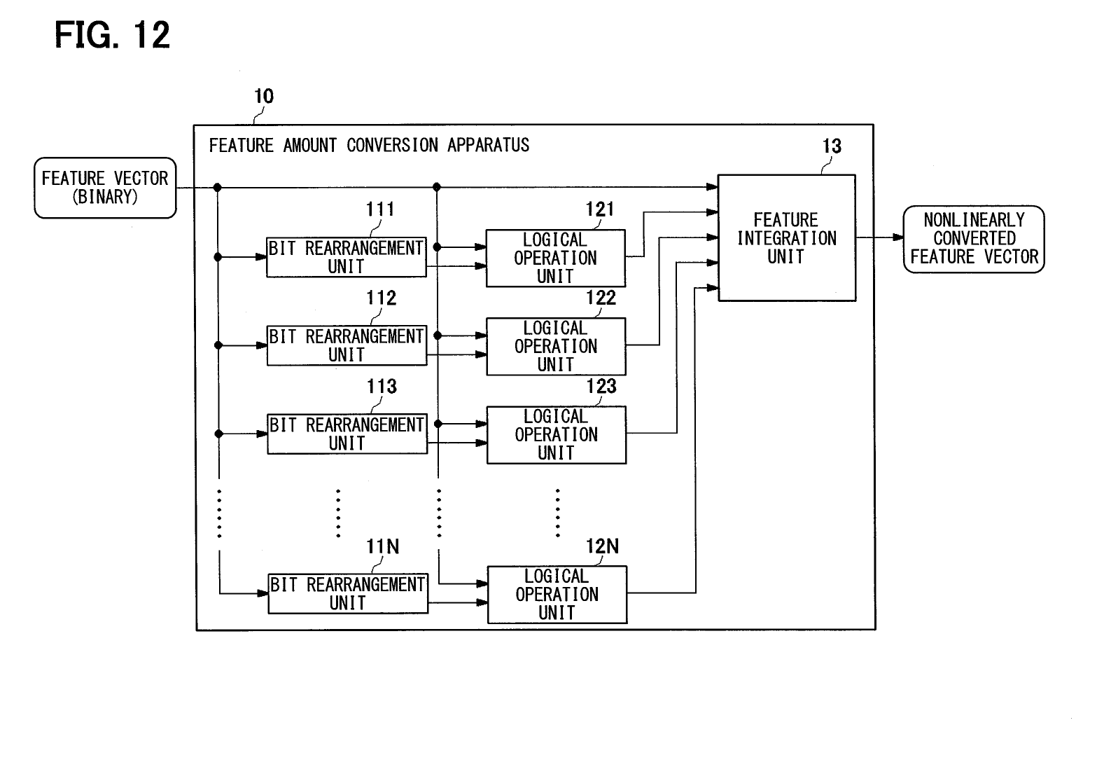

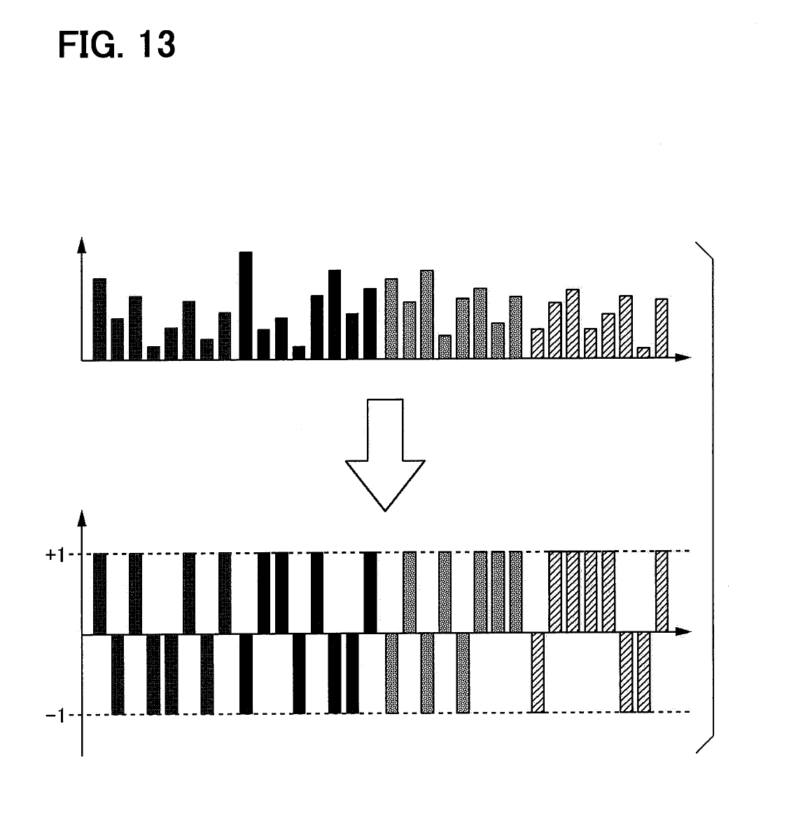

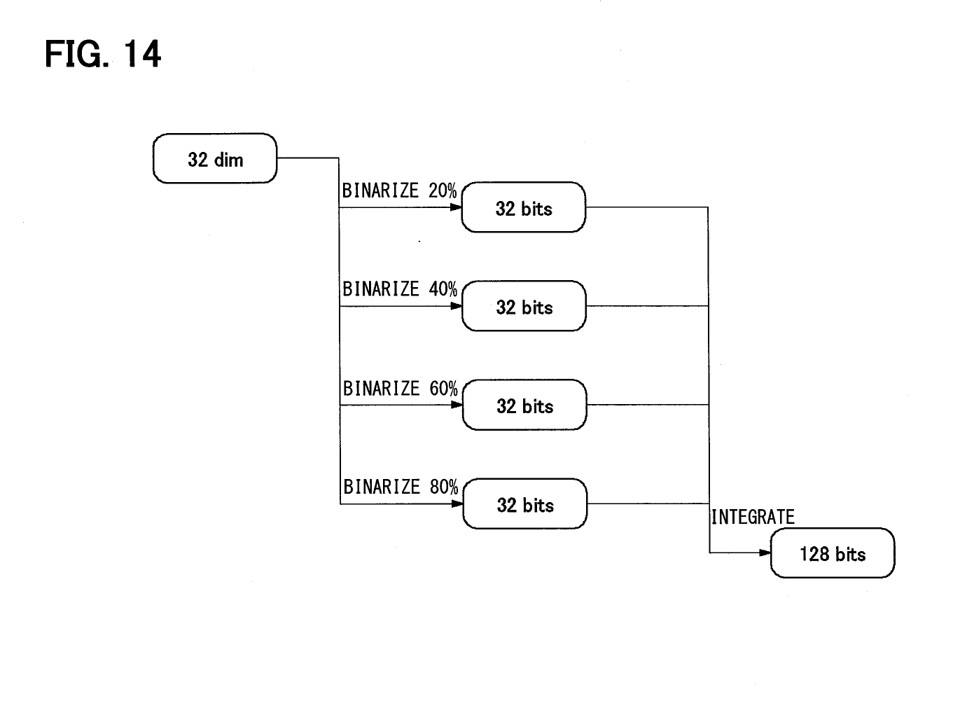

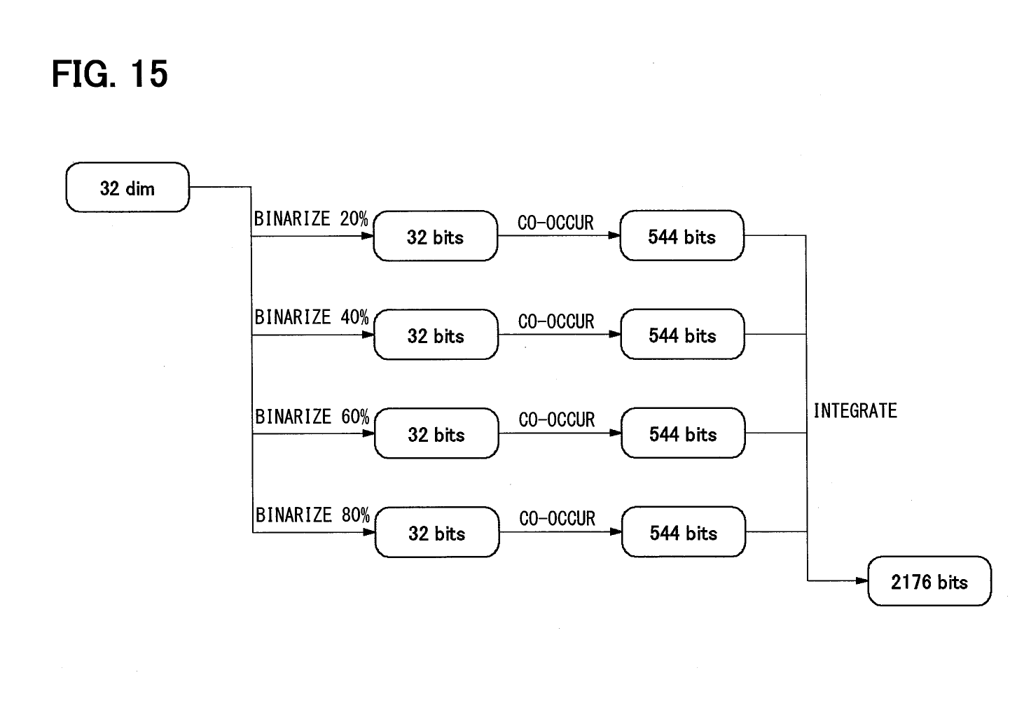

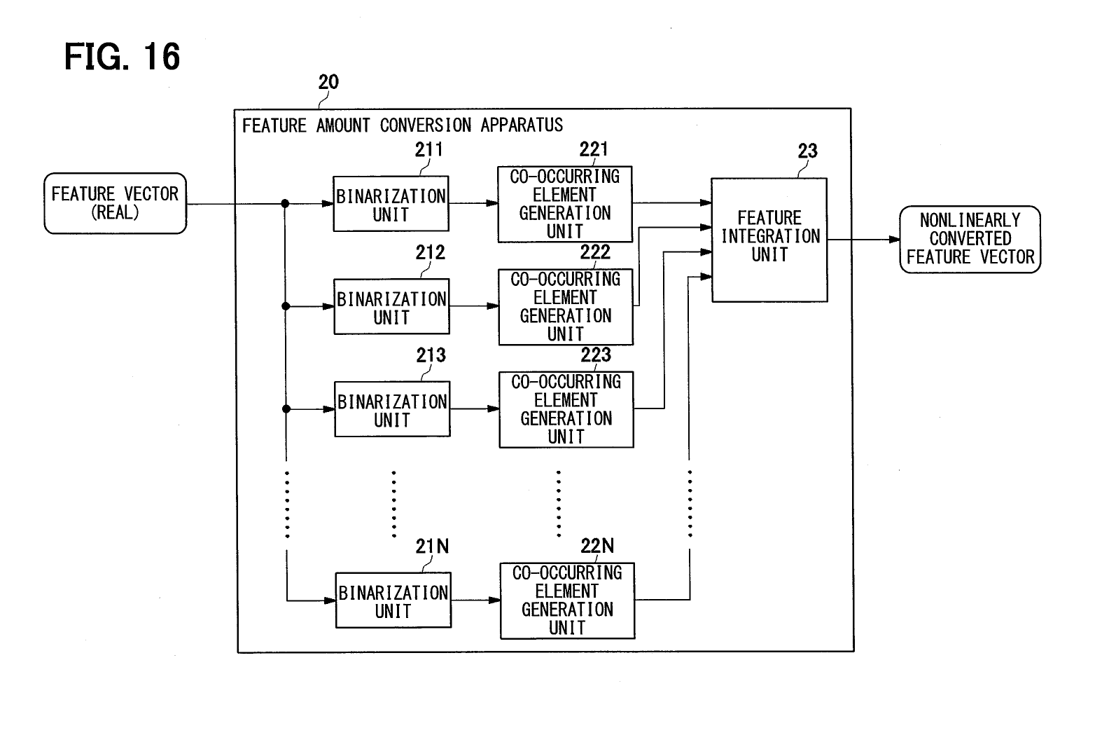

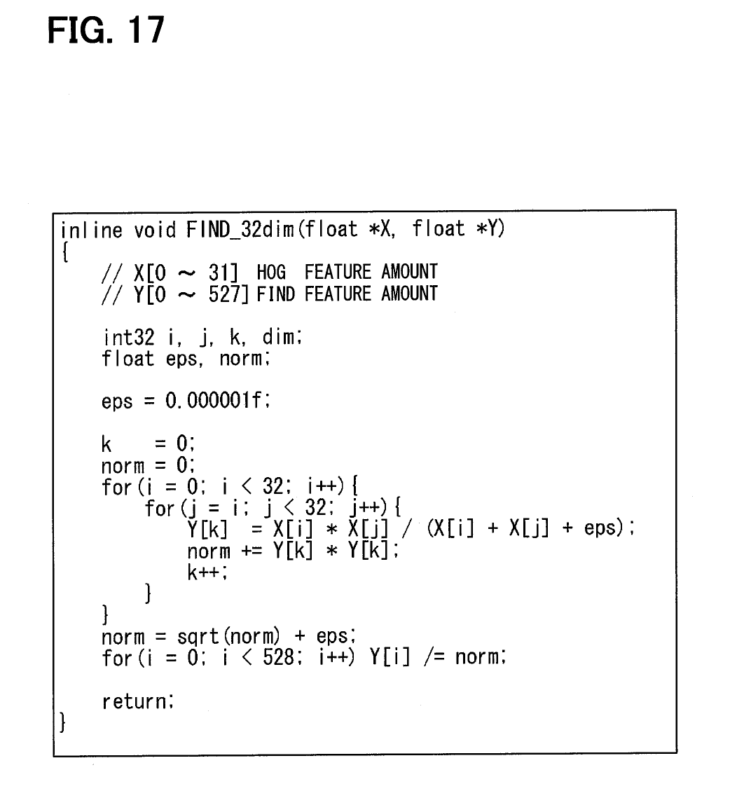

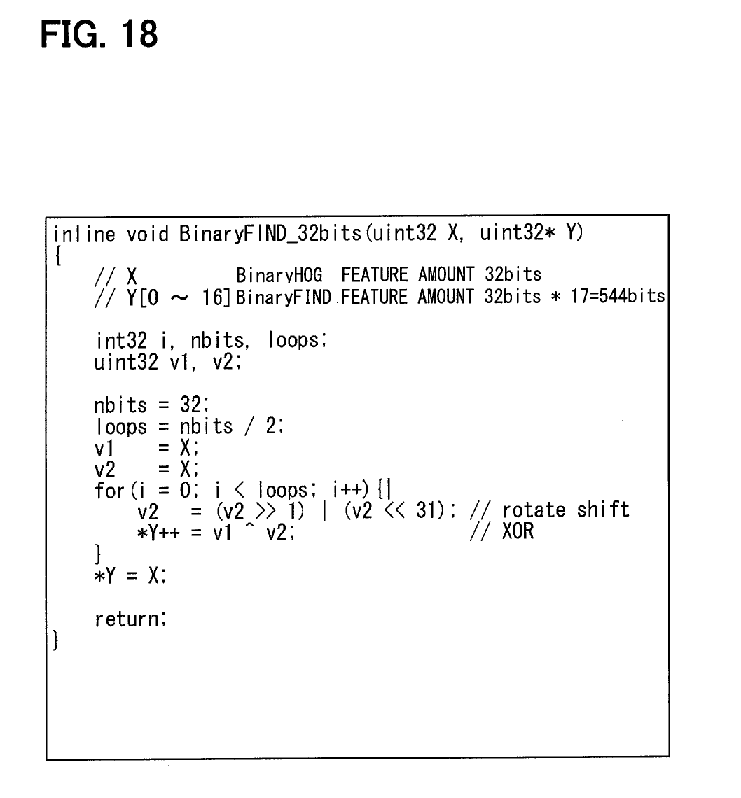

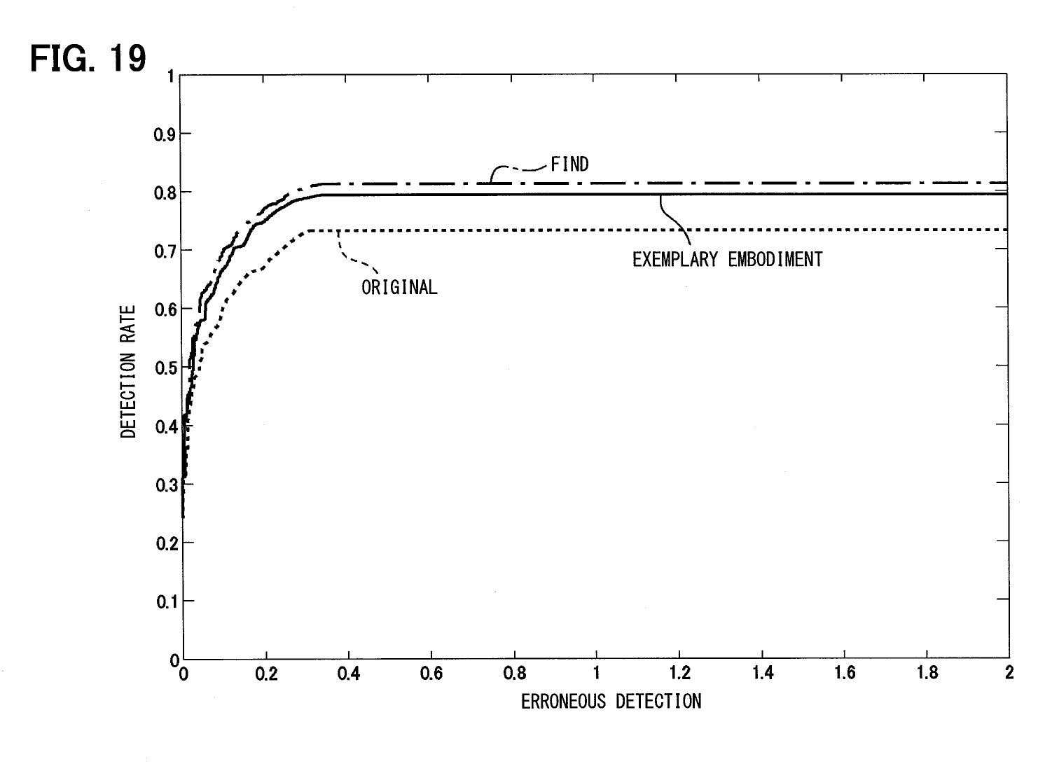

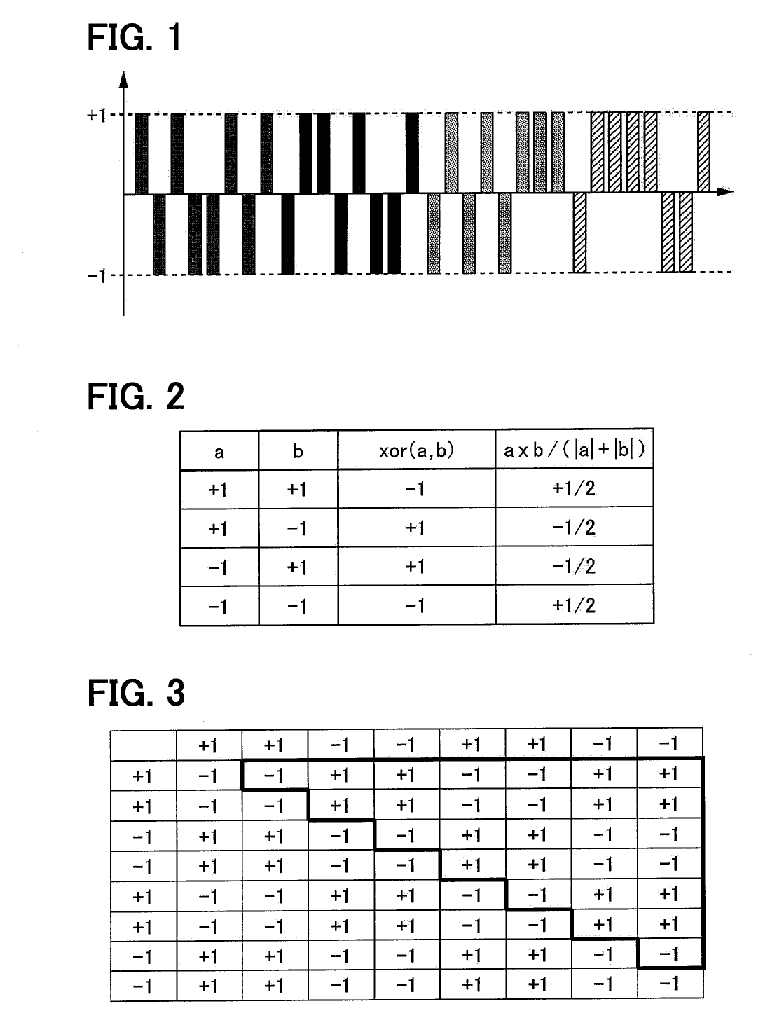

FIG. 1 is a diagram illustrating exemplary elements of a binary feature vector. Each of the elements of a feature vector takes a value of +1 or −1. In FIG. 1, the vertical axis represents the value of each element, and the horizontal axis represents the number of elements (the number of dimensions). In the example of FIG. 1, the number of elements is 32.

When a FIND feature amount is to be determined, the elements are used to calculate a harmonic mean as indicated in Formula (2).

a×b/(|a|+|b|) (2)

where a and b are the value of each element (+1 or −1). As a and b are either +1 or −1, the number of their combinations is limited to four. Therefore, when the elements of the feature vector are binarized to either +1 or −1, their harmonic mean is equivalent to the XOR.

FIG. 2 is a diagram illustrating the relationship between the XOR and the harmonic mean. As in FIG. 2, the relationship between the XOR and the harmonic mean is such that (−½)×XOR=harmonic mean. Therefore, a feature amount having an improved discrimination capability comparable to a FIND feature amount can be derived from conversion even when the XOR of all combinations of a binary feature amount having a value of +1 or −1 is determined instead of determining the harmonic mean of all such combinations. The feature amount conversion apparatus according to the present embodiment therefore determines the XOR of the combinations of a binary feature vector having a value of +1 or −1, providing an improved discrimination capability.

FIG. 3 is a diagram illustrating the XOR of all combinations of elements of a binary feature vector having a value of 1 or −1. For the sake of brevity, FIG. 3 illustrates a case where the number of dimensions of the binary feature vector is 8. A sequence of numbers in the first row and a sequence of numbers in the first column represent a feature vector. In the example of FIG. 3, the feature vector is (+1, +1, −1, −1, +1, +1, −1, −1).

As is obvious from Formula (2), the harmonic mean remains unchanged even if a and b are interchanged. Thus, a portion enclosed by a thick line in FIG. 3 corresponds to a portion excluding an overlap of the XOR of all combinations of elements of the feature vector. In the present embodiment, therefore, this portion is adopted as a set of co-occurring elements. As the XOR of identical elements is −1 at all times, such elements are adopted as co-occurring elements in the present embodiment.

When the elements of an original feature vector in the present embodiment are arranged together with the elements (co-occurring elements) enclosed by the thick line in FIG. 3, a feature amount comparable to a FIND feature amount is obtained. In this instance, the co-occurring elements can be rapidly calculated by performing a rotate shift operation with no carry on the original feature vector and calculating the XOR of its elements.

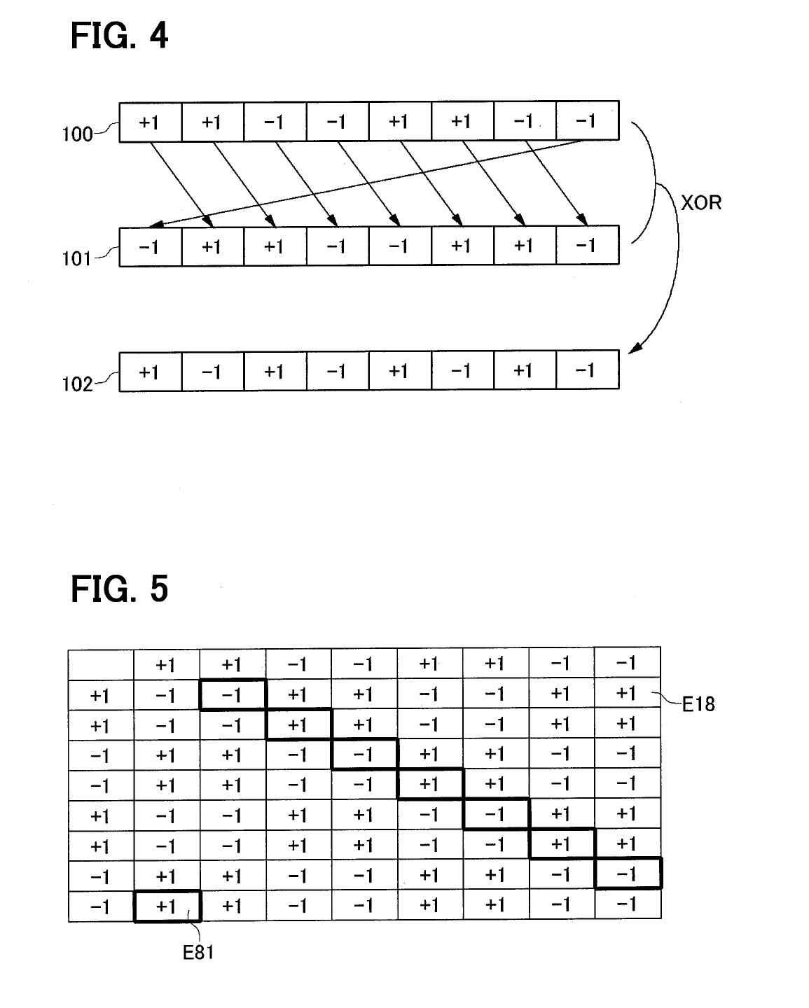

FIG. 4 is a diagram illustrating a process of calculating co-occurring elements by performing a rotate shift operation with no carry. A rearranged bit string 101 is prepared by performing a rotate shift operation with no carry, that is, by shifting a bit string 100 of an original feature vector by one bit to the right and placing the rightmost bit in the first bit position (leftmost position). The XOR of the bit string 100 and the rearranged bit string 101 is then determined to obtain a logically-operated bit string 102. The logically-operated bit string 102 serves as co-occurring elements.

FIG. 5 illustrates the XOR of all combinations of the elements of a binary feature vector again. The logically-operated bit string 102 in FIG. 4 corresponds to a portion enclosed by a thick line in FIG. 5. Element E81 is identical with element E18.

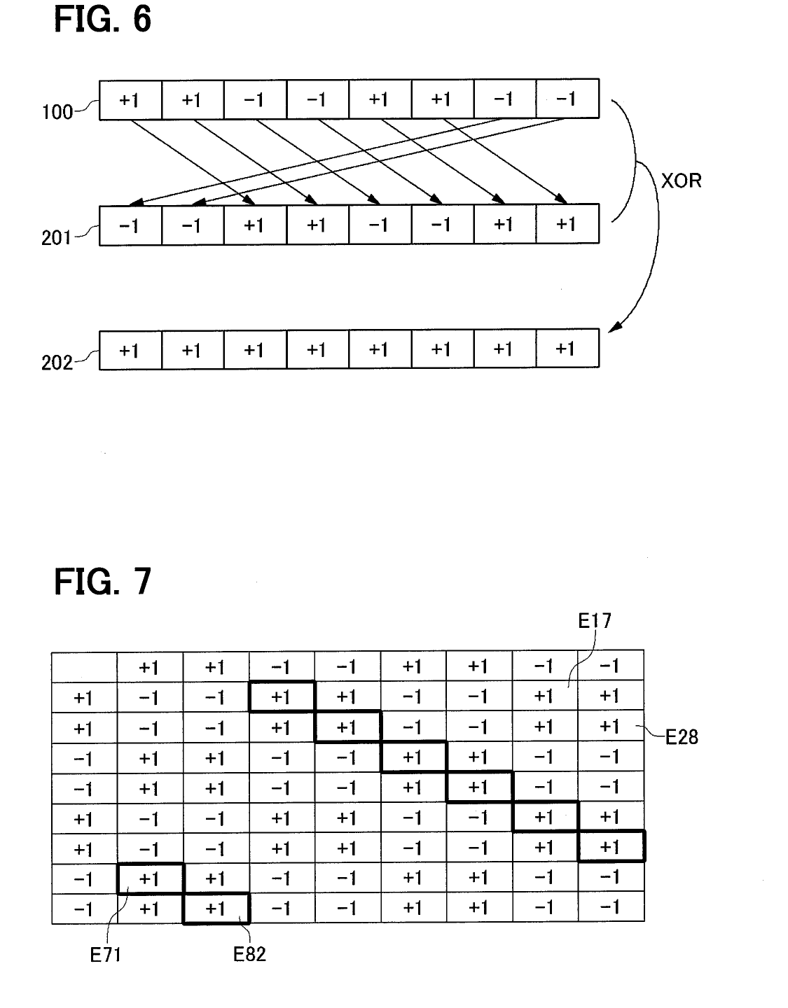

FIG. 6 is a diagram illustrating a process of calculating co-occurring elements by performing a rotate shift operation with no carry. A rearranged bit string 201 is prepared by performing a rotate shift operation with no carry, that is, by shifting the bit string 100 of the original feature vector by two bits to the right and placing the rightmost two bits respectively in the first and second bit positions. The XOR of the bit string 100 and the rearranged bit string 201 is then determined to obtain a logically-operated bit string 202. The logically-operated bit string 202 serves as co-occurring elements.

FIG. 7 illustrates the XOR of all combinations of the elements of a binary feature vector. The logically-operated bit string 202 in FIG. 6 corresponds to a portion enclosed by a thick line in FIG. 7. Elements E71 and E82 are identical with elements E17 and E28, respectively.

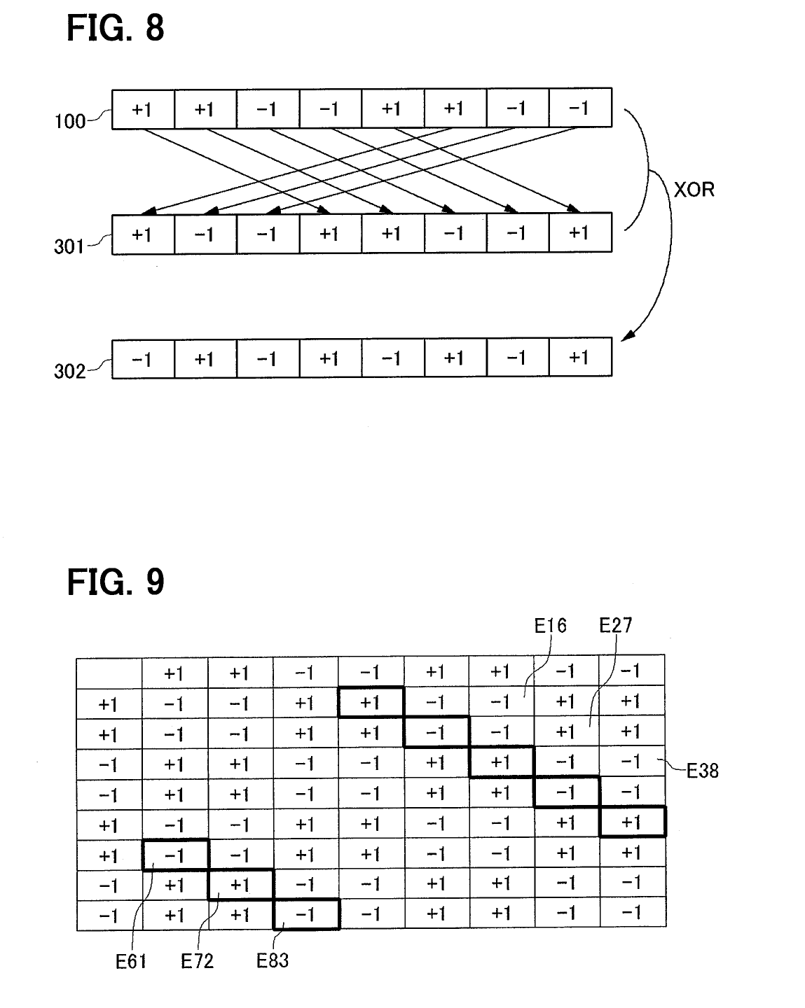

FIG. 8 is a diagram illustrating a process of calculating co-occurring elements by performing a rotate shift operation with no carry. A rearranged bit string 301 is prepared by performing a rotate shift operation with no carry, that is, by shifting the bit string 100 of the original feature vector by three bits to the right and placing the rightmost three bits respectively in the first, second, and third bit positions. The XOR of the bit string 100 and the rearranged bit string 301 is then determined to obtain a logically-operated bit string 302. The logically-operated bit string 302 serves as co-occurring elements.

FIG. 9 illustrates the XOR of all combinations of the elements of a binary feature vector. The logically-operated bit string 302 in FIG. 8 corresponds to a portion enclosed by a thick line in FIG. 9. Elements E61, E72, and E83 are identical with elements E16, E27, and E38, respectively.

FIG. 10 is a diagram illustrating a process of calculating co-occurring elements by performing a rotate shift operation with no carry. A rearranged bit string 401 is prepared by performing a rotate shift operation with no carry, that is, by shifting the bit string 100 of the original feature vector by four bits to the right and placing the rightmost four bits respectively in the first, second, third, and fourth bit positions. The XOR of the bit string 100 and the rearranged bit string 401 is then determined to obtain a logically-operated bit string 402. The logically-operated bit string 402 serves as co-occurring elements.

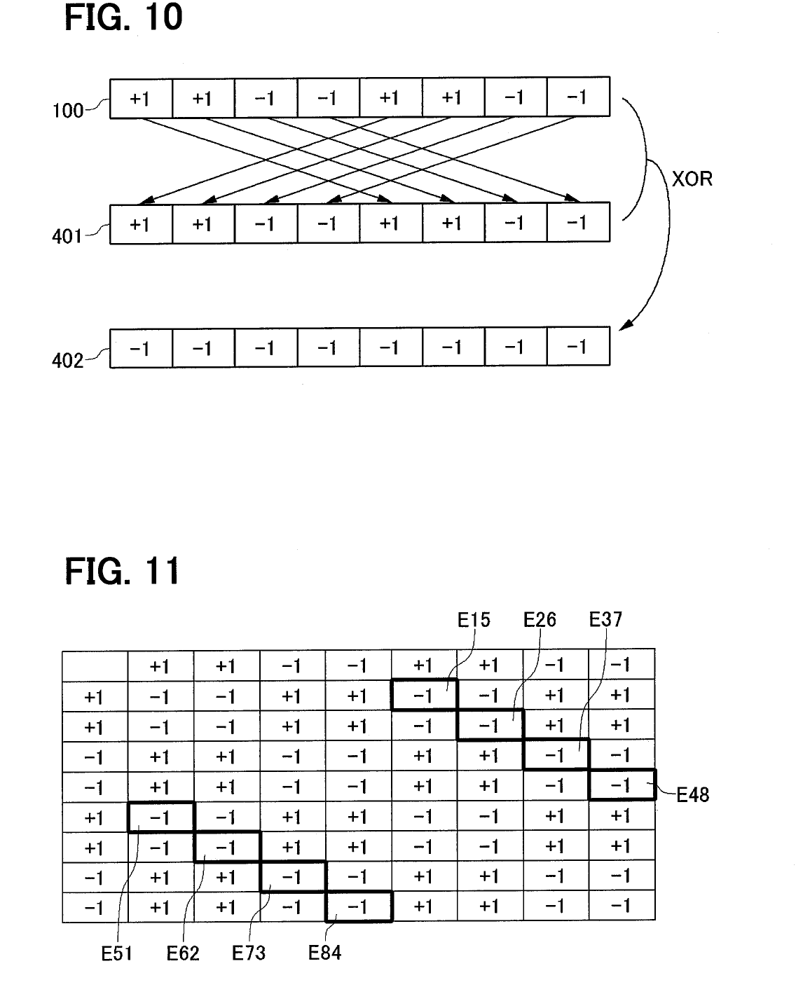

FIG. 11 illustrates the XOR of all combinations of the elements of a binary feature vector. The logically-operated bit string 402 in FIG. 10 corresponds to a portion enclosed by a thick line in FIG. 11. Elements E51, E62, D73, and E81 are identical with elements E15, E26, E37, and E48, respectively. Therefore, either of these two sets of elements is unnecessary. For the convenience of calculations, however, these two sets of elements are used without being discarded.

When calculations are performed as indicated in FIGS. 4, 6, 8, and 10, all elements enclosed by the thick line in FIG. 3 are calculated. In other words, the calculations of co-occurring elements of an 8-bit feature vector can be completed by performing a rotate shift operation with no carry four times and calculating the XOR four times. Similarly, when the number of bits (the number of dimensions) of a binary feature vector is 32, the calculations of co-occurring elements can be completed by performing a rotate shift operation with no carry sixteen times and calculating the XOR sixteen times. In general, when the number of bits (the number of dimensions) of a binary feature vector is d, the calculations of co-occurring elements can be completed by performing a rotate shift operation with no carry d/2 times and calculating the XOR d/2 times.

The feature amount conversion apparatus acquires a nonlinearly converted feature vector by adding the elements of the original feature vector to the co-occurring elements obtained as described. Hence, when a 32-dimensional binary feature vector is converted, the number of dimensions of the resulting nonlinearly converted feature vector is 32×16+32=544. A configuration of the feature amount conversion apparatus that achieves the above conversion of a feature vector will be described below.

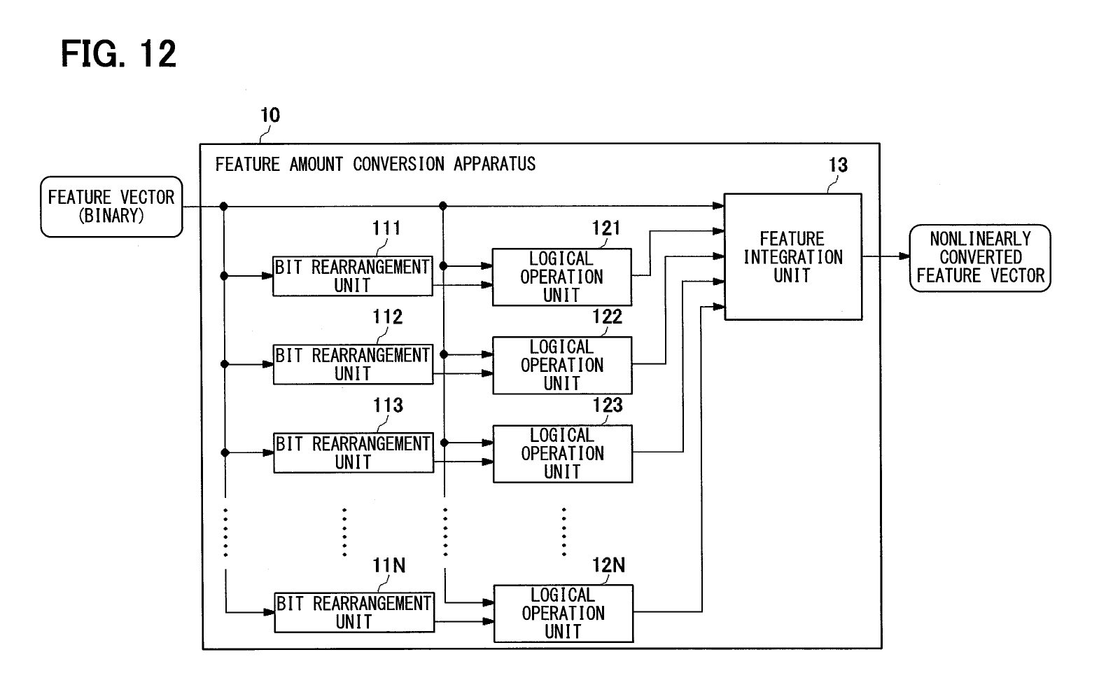

FIG. 12 is a diagram illustrating a configuration of the feature amount conversion apparatus according to the present embodiment. The feature amount conversion apparatus 10 includes N bit rearrangement units 111-11N, N logical operation units 121-12N, and a feature integration unit 13. The N bit rearrangement units 111-11N may be also referred to as N bit rearrangement portions 111-11N; the N logical operation units 121-12N may be also referred to as N logical operation portions 121-12N; and the feature integration unit 13 may be also referred to as a feature integration portion 13. The number of bit rearrangement units 111-11N is the same as the number of logical operation units 121-12N. The whole or part of the bit rearrangement units 111-11N, the logical operation units 121-12N, and the feature integration unit 13 may be implemented by allowing a computer to execute a feature amount conversion program or implemented by hardware.

In the present embodiment, a binarized feature vector is inputted to the feature amount conversion apparatus 10 as the feature amount to be converted. The feature vector is inputted to the N bit rearrangement units 111-11N and the N logical operation units 121-12N, respectively. Further, the N logical operation units 121-12N receive outputs generated from the corresponding bit rearrangement units 111-11N.

The bit rearrangement units 111-11N generate a rearranged bit string by performing a rotate shift operation with no carry on the inputted binary feature vector. More specifically, the bit rearrangement unit 111 performs a rotate shift operation with no carry to shift the feature vector by one bit to the right, the bit rearrangement unit 112 performs a rotate shift operation with no carry to shift the feature vector by two bits to the right, the bit rearrangement unit 113 performs a rotate shift operation with no carry to shift the feature vector by three bits to the right, and the bit rearrangement unit 11N performs a rotate shift operation with no carry to shift the feature vector by N bits to the right.

In the present embodiment, when an inputted binary feature vector is d-dimensional, N=d/2. This can calculate the XOR of all combinations of all elements of the feature vector.

The logical operation units 121-12N calculate the XOR of the bit string of the original feature vector and the rearranged bit string outputted respectively from the bit rearrangement units 111-11N. More specifically, the logical operation unit 121 calculates the XOR of the bit string of the original feature vector and the rearranged bit string outputted from the bit rearrangement unit 111 (see FIG. 4), the logical operation unit 122 calculates the XOR of the bit string of the original feature vector and the rearranged bit string outputted from the bit rearrangement unit 112 (see FIG. 6), the logical operation unit 123 calculates the XOR of the bit string of the original feature vector and the rearranged bit string outputted from the bit rearrangement unit 113 (see FIG. 8), and the logical operation unit 12N calculates the XOR of the bit string of the original feature vector and the rearranged bit string outputted from the bit rearrangement unit 11N.

A feature integration unit 13 arranges the original vector together with the outputs (logically-operated bit strings) generated from the logical operation units 121-12N and generates a nonlinearly converted feature vector that includes them as elements. As mentioned, when the inputted feature vector is 32-dimensional, the nonlinearly converted feature vector generated by the feature integration unit 13 is 544-dimensional.

As described, the feature amount conversion apparatus 10 according to the present embodiment increases the number of dimensions of a binarized feature vector by adding the elements of the binarized feature vector to their co-occurring elements (elements of a logically-operated bit string). This can improve the discrimination capability of a feature vector.

Further, as the elements of the original feature vector are either +1 or −1, handling the harmonic mean of the elements as a co-occurring element as in the case of a FIND feature amount is equivalent to handling the XOR of the individual elements as a co-occurring element. The feature amount conversion apparatus 10 according to the present embodiment therefore calculates the XORs of all combinations of the individual elements and handles the calculated XORs as co-occurring elements. Consequently, the co-occurring elements can be rapidly calculated.

Furthermore, in order to calculate the XOR of the individual elements, the feature amount conversion apparatus 10 according to the present embodiment calculates the XOR of the bit string of the original feature vector and a bit string obtained by performing a rotate shift operation with no carry on the bit string of the original feature vector. Therefore, when the width of a computer register is not greater than the number of bits of the original feature vector (the number of XOR calculations), this XOR can be simultaneously calculated. Consequently, the co-occurring elements can be rapidly calculated.

### Second Embodiment

The feature amount conversion apparatus according to a second embodiment of the present disclosure will now be described. When a HOG feature amount is acquired as a real vector instead of a binary vector, the feature amount conversion apparatus according to the second embodiment converts the real vector to a binary vector having a high discrimination capability.

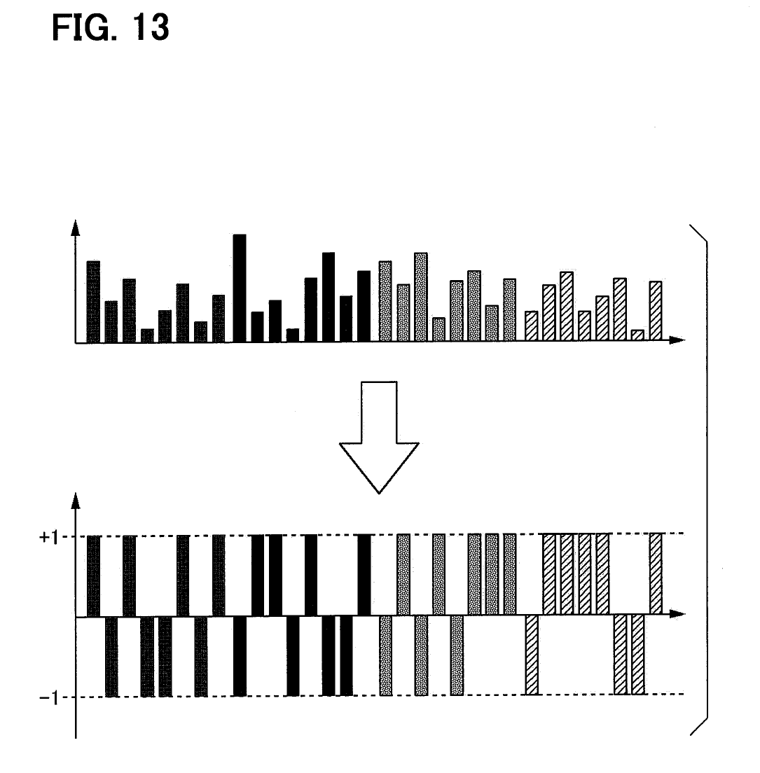

FIG. 13 is a diagram illustrating a HOG feature amount of one block of image and the result obtained by binarizing the HOG feature amount. In the present embodiment, the HOG feature amount is acquired as a 32-dimensional feature vector. The upper half of FIG. 13 illustrates the elements of the feature vector. The vertical axis represents the magnitude of each element, and the horizontal axis represents the number of elements.

The individual elements are binarized to obtain a binarized feature vector as in the lower half of FIG. 13. More specifically, a threshold value for binarization is defined at a predetermined position in the range of each element. If the value of an element is not smaller than the threshold value, the element is considered to be +1. If, by contrast, the value of an element is smaller than the threshold value, the element is considered to be −1. As the range varies from one element to another, different threshold values (32 different threshold values) are set for the individual elements. When each of the elements of 32 real numbers of the feature vector is binarized, a binarized feature vector (32-bit) having 32 elements is derived from conversion.

Here, the use of a multiple threshold value can enhance the feature description capability of the feature vector (increase the amount of information in the feature vector). In other words, when k different threshold values are set and individually binarized as in FIG. 13, the number of dimensions of the binarized feature vector can be increased.

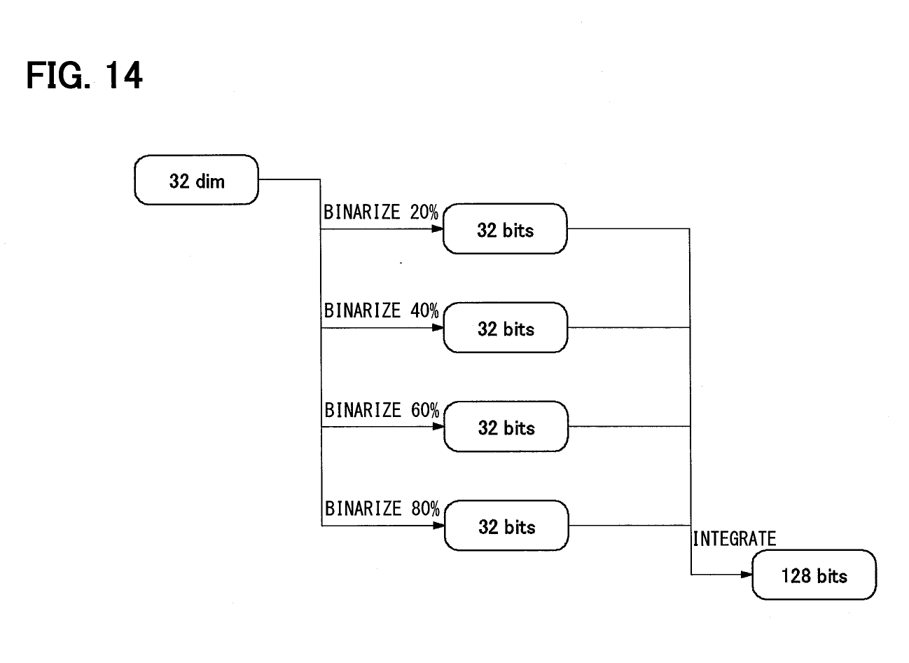

FIG. 14 is a diagram illustrating how the feature description capability is enhanced by a multiple threshold value. In the example of FIG. 14, four different threshold values are used for binarization purposes. The elements of a 32-dimensional real vector are binarized by using a threshold value set at a 20% position in their range, and 32 bits of element are thus generated. Similarly, the elements of a 32-dimensional real vector are binarized by using a threshold value set at a 40% position in their range, at a 60% position in their range, and at an 80% position in their range, and 32 bits of element are thus reproduced, respectively. When these elements are integrated, a binarized 128-dimensional feature vector (128-bit) is obtained.

When a feature vector is given as a real vector, the feature description capability of the feature vector can be enhanced by binarization based on a multiple threshold value as in FIG. 14. Besides, the amount of information can be further increased by allowing the feature amount conversion apparatus 10 described in conjunction with the first embodiment to perform nonlinear conversion.

A scheme for increasing the speed of HOG feature amount binarization will now be described. In general, the length of a HOG feature amount needs to be normalized to 1 on an individual block basis. The reason is that such normalization provides robustness against brightness.

An unnormalized, 32-dimensional, real HOG feature amount is expressed by [Expression 1].

h=(h₁,h₂, . . . ,h₃₂)^{T} [Expression 1]

Further, a normalized, 32-dimensional, real HOG feature amount is expressed by [Expression 2].

h̅=( h̅₁, h̅₂, . . . , h̅₃₂)^{T} [Expression 2]

In this instance, [Expression 3] is obtained.

$${\overline{h}}_{i} = \frac{{h}_{i}}{\sqrt{{\sum }_{k = 1}^{32} {h}_{k}^{2}}} \qquad [ Expression 3 ]$$

A binarized, 32-dimensional HOG feature amount is expressed by [Expression 4].

b=(b₁,b₂, . . . ,b₃₂)^{T} [Expression 4]

In this instance, [Expression 5] is obtained.

$${b}_{i} = \{ \begin{matrix}+ 1 & if {h}_{i} > {T}_{i} \\ - 1 & otherwise\end{matrix} \qquad [ Expression 5 ]$$

The above binarization is very slow because one square root calculation and one division operation are involved. Therefore, it is well to remember that the HOG feature amount is nonnegative. Thus, the above inequality expression is used as [Expression 6].

h̅ₗ>Tᵢ [Expression 6]

[Expression 7] below is obtained by squaring both sides of [Expression 6] and transposing the denominator on the left side to the right side.

hᵢ²>Tᵢ²Σₖ₌₁³²hₖ² [Expression 7]

Through the above deformation, the real HOG feature amount can be binarized by [Expression 8] below without calculating a square root or performing a division operation.

$${b}_{i} = \{ \begin{matrix}+ 1 & if {h}_{i}^{2} > {T}_{i}^{2} {\sum }_{k = 1}^{32} {h}_{k}^{2} \\ - 1 & otherwise\end{matrix} \qquad [ Expression 8 ]$$

When, for instance, an element is determined to be −1 (smaller than a threshold value) as a result of binarization achieved by using the 20% position in the range as the threshold value, the element is naturally determined to be −1 when binarization is achieved by using the 40% position, 60% position, and 80% position in the range as the threshold value. In this sense, a 128-bit binarized vector obtained by binarization based on a multiple threshold value includes redundant elements. Therefore, it is not an efficient way to determine the co-occurring elements by directly applying the 128-bit binarized vector to the feature amount conversion apparatus 10 according to the first embodiment. In view of the above circumstances, the present embodiment provides a feature amount conversion apparatus that is capable of efficiently determining the co-occurring elements by reducing the above redundancy.

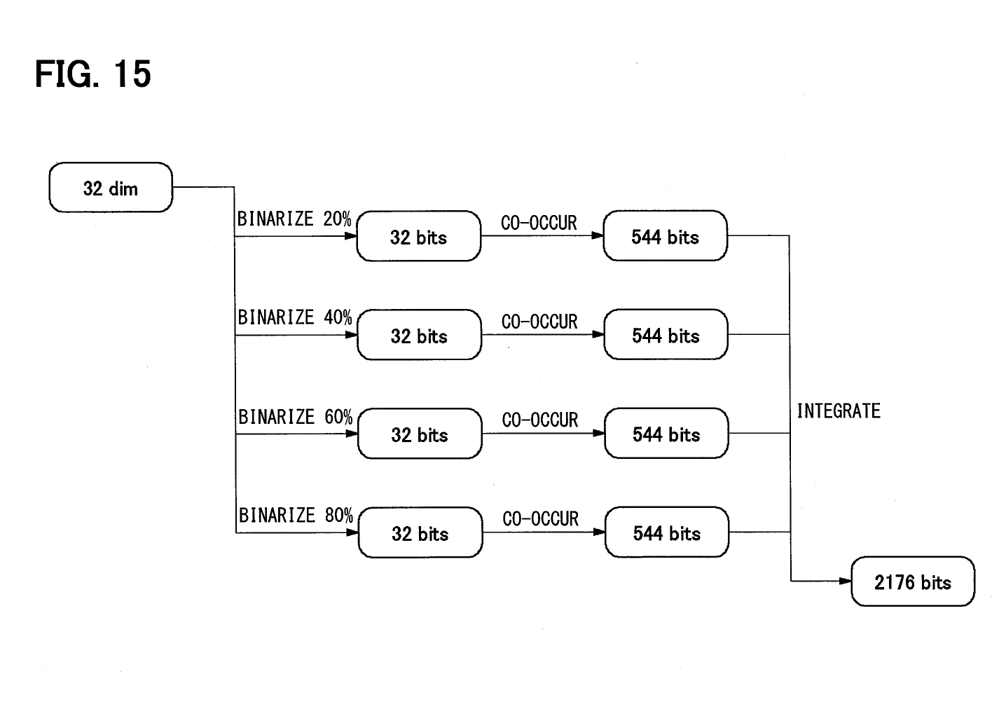

FIG. 15 is a diagram illustrating a feature amount conversion in the present embodiment. The feature amount conversion apparatus according to the present embodiment binarizes a feature vector, which is obtained as a real vector, by using k different threshold values. In the example of FIG. 15, bit strings having 32 elements are obtained by binarizing a 32-dimensional real vector with four different threshold values, which are at 20%, 40%, 60%, and 80% positions in the range. So far, the employed scheme is the same as in the example of FIG. 14.

Before integrating the bit strings obtained based on the threshold values, the feature amount conversion apparatus according to the present embodiment uses the bit strings to determine co-occurring elements. Hence, 544-bit bit strings can be obtained from 32-bit bit strings, as in FIG. 15. Eventually, the obtained four bit strings are integrated to acquire a 2176-bit, binarized, nonlinearly converted feature vector.

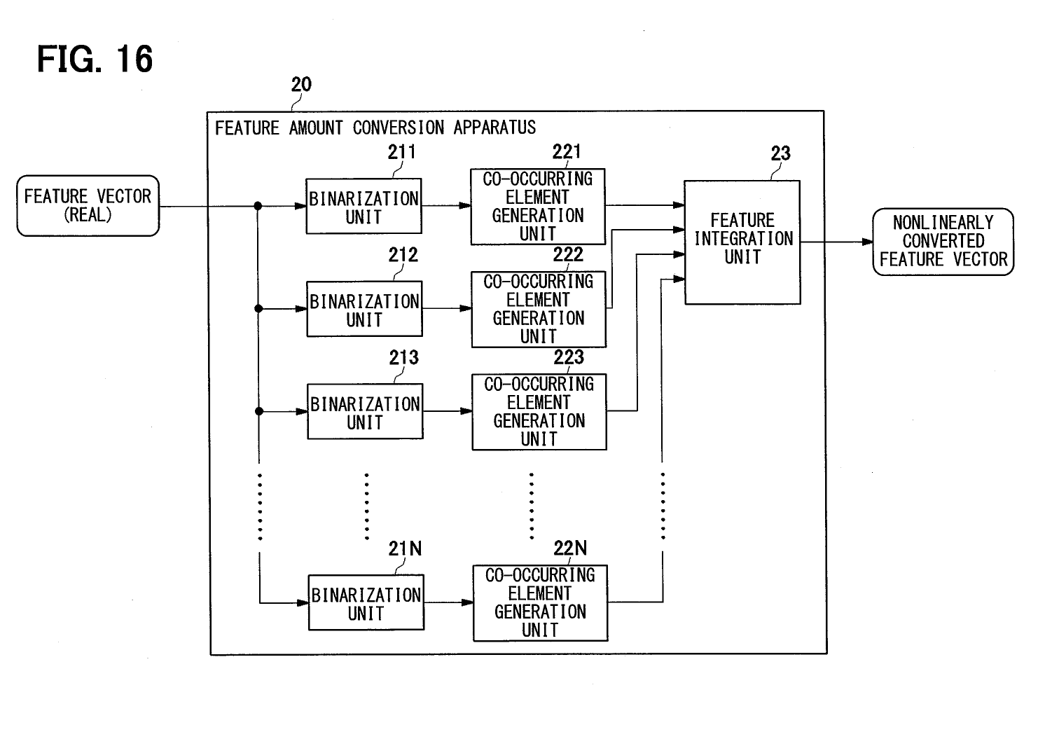

FIG. 16 is a block diagram illustrating a configuration of the feature amount conversion apparatus according to the present embodiment. The feature amount conversion apparatus 20 includes N binarization units 211-21N, N co-occurring element generation units 221-22N, and a feature integration unit 23. The N binarization units 211-21N may be also referred to as N binarization portions 211-21N; the N co-occurring element generation units 221-22N may be also referred to as N co-occurring element portions 221-22N; and the feature integration unit 23 may be also referred to as a feature integration portion 23. The number of binarization units 211-21N is the same as the number of co-occurring element generation units 221-22N. The whole or part of the binarization units 211-21N, the co-occurring element generation units 221-22N, and the feature integration unit 23 may be implemented by allowing a computer to execute a feature amount conversion program or implemented by hardware.

In the present embodiment, a real feature vector is inputted to the feature amount conversion apparatus 20. The feature vector is inputted to the N binarization units 211-21N. The binarization units 211-21N binarize the real feature vector with different threshold values. The binarized feature vectors are respectively inputted to the corresponding co-occurring element generation units 221-22N.

The co-occurring element generation units 221-22N each have the same configuration as the feature amount conversion apparatus 10 described in conjunction with the first embodiment. More specifically, the co-occurring element generation units 221-22N each include a plurality of bit rearrangement units 111-11N, a plurality of logical operation units 121-12N, and a feature integration unit 13, calculate co-occurring elements by performing a rotate shift operation with no carry and an XOR operation, and integrate the calculated co-occurring elements with inputted bit strings.

When a 32-bit bit string is inputted to each co-occurring element generation unit 221-22N, each co-occurring element generation unit 221-22N outputs a 544-bit bit string. The feature integration unit 23 arranges outputs generated from the co-occurring element generation unit 221-22N and generates a nonlinearly converted feature vector that includes them as elements. As mentioned, when the inputted feature vector is 32-dimensional, the feature vector generated by the feature integration unit 23 is 2176-dimensional (2176-bit).

As described, even when the feature amount is obtained as a real vector, the feature amount conversion apparatus 20 according to the present embodiment is capable of binarizing the real vector and increasing the amount of information in the binarized vector.

When determining a recognition model from many learning data, the feature amount conversion apparatus 10 according to the first embodiment and the feature amount conversion apparatus 20 according to the second embodiment acquire a nonlinearly converted feature vector by performing the above nonlinear conversion on a feature vector inputted as learning data. The nonlinearly converted feature is used for a learning process performed by a learning apparatus on the basis, for instance, of SVM, and a recognition model is determined. In other words, the feature amount conversion apparatuses 10, 20 are used for the learning apparatus. Further, even when the recognition model is determined and the data to be recognized is inputted as a feature vector that is in the same form as the learning data, the feature amount conversion apparatuses 10, 20 perform the above nonlinear conversion on the feature vector to acquire a nonlinearly converted feature vector. The nonlinearly converted feature vector is used, for instance, for linear discrimination by a recognition apparatus, and a recognition result is obtained. In short, the feature amount conversion apparatuses 10, 20 can be used for the recognition apparatus.

It should be noted that the logical operation units 121-12N need not always perform a logical operation by calculating XOR. The logical operation units 121-12N may alternatively perform the logical operation by calculating, for example, AND or OR. However, if the XOR is equivalent to a harmonic mean for determining the FIND feature amount, as described, and the feature vector is arbitrary as is obvious from FIG. 2, a value of +1 and a value of −1 equiprobably arise as the XOR value. This will increase the entropy of co-occurring elements (increase the amount of information) and enhance the description capability of the nonlinearly converted feature vector. Therefore, it is of advantage that the logical operation units 121-12N calculate XOR.

The feature amount conversion apparatus 10 and the co-occurring element generation units 221-22N include d/2 bit rearrangement units 111-11N when the number of dimensions of a feature vector is d. However, the number of bit rearrangement units may be smaller than d/2 (N=1 is acceptable) or larger than d/2. Further, the number of logical operation units 121-12N may be smaller than d/2 (N=1 is acceptable) or larger than d/2.

The bit rearrangement units 111-11N generates a new bit string by performing a rotate shift operation with no carry on the bit string of the original feature vector. Alternatively, however, the bit rearrangement units 111-11N may generate a new bit string, for example, by randomly rearranging the bit string of the original feature vector. However, performing a carry rotate operation with no shift is advantageous in that it covers all combinations with a minimum number of bits, is based on a simple logic, and has a high processing speed.

The logical operation units 121-12N perform a logical operation on the bit string of the original feature vector and bit strings rearranged by the bit rearrangement units. Alternatively, however, some or all of the logical operation units may perform a logical operation on the bit strings rearranged by the bit rearrangement units. In such an instance, the number of dimensions of the bit strings acquired by the bit rearrangement units may differ from the number of dimensions of the original feature vector. The inputs and outputs of the binarization units 211-21N may differ in dimension. The feature integration unit 13 generates a nonlinearly converted feature vector by using the elements of the original feature vector as well. Alternatively, however, the feature integration unit 13 may generate the nonlinearly converted feature vector without using the original feature vector.

The co-occurring element generation units 221-22N in the second embodiment each have the same configuration as the feature amount conversion apparatus 10 according to the first embodiment, that is, include the bit rearrangement units 111-11N, the logical operation units 121-12N, and the feature integration unit 13. However, an alternative is to provide the co-occurring element generation units 221-22N with no feature integration unit 13, output a plurality of logically-operated bit strings, which are outputted from the logical operation units 121-12N, directly to the feature integration unit 23, and let the feature integration unit 23 integrate the logically-operated bit strings to generate the nonlinearly converted feature vector.

(Modifications)

The first and second embodiments have been described on the assumption that they are applied to discriminate images. Alternatively, however, other data, such as voice and text, may be adopted as a discrimination target. Further, a recognition process other than a linear discrimination process may be alternatively performed.

In the first and second embodiments, the bit rearrangement units 111-11N each generate a rearranged bit string, and a plurality of rearranged bit strings are thereby generated. Further, the logical operation units 121-12N each perform a logical operation to calculate the XOR of each of the rearranged bit strings and the bit string of the original feature vector. These bit rearrangement units 111-11N and logical operation units 121-12N correspond to bit rearrangement portions and logical operation portions according to the present disclosure. However, the bit rearrangement portions and logical operation portions according to the present disclosure are not limited to the corresponding units in the foregoing embodiments. Alternatively, software may be executed to generate a plurality of rearranged bits and perform a plurality of logical operations.

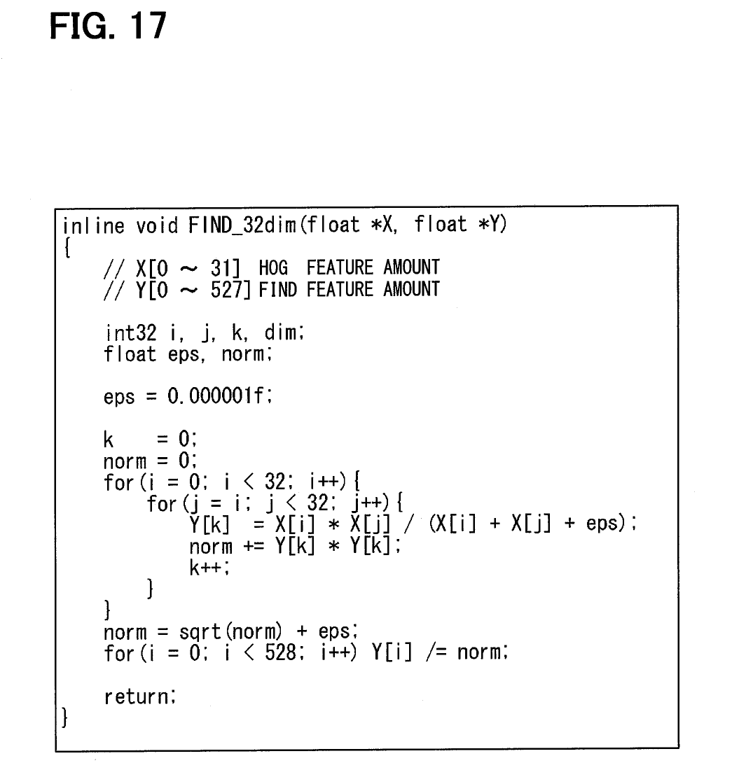

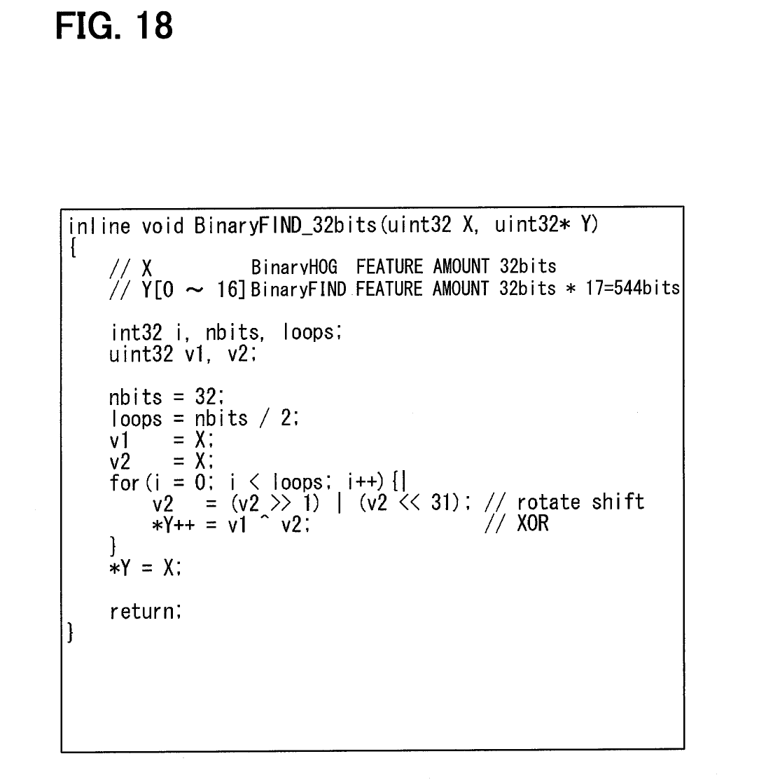

An exemplary embodiment based on the use of the feature amount conversion apparatus according to the foregoing embodiments of the present disclosure will now be described. FIG. 17 illustrates program codes of a comparative example. FIG. 18 illustrates program codes of the exemplary embodiment. The comparative example represents a program that converts a feature amount having 32-dimensional, real elements to a FIND feature amount. The exemplary embodiment represents a program that causes the feature amount conversion apparatus 10 according to the first embodiment to perform nonlinear conversion on a feature amount having 32-dimensional, binarized elements. For the sake of explanation, the symbol k represents the number of threshold steps for binarization.

The programs represented by the comparative example and the exemplary embodiment were used to convert the same pseudo data. The calculation time per block was therefore 7212.71 nanoseconds in the comparative example. Meanwhile, in the comparative example, the calculation time per block was 22.04 nanoseconds (327.32 times the speed of the comparative example) when k=1, 33.20 nanoseconds (217.22 times the speed of the comparative example) when k=2, 42.14 nanoseconds (171.17 times the speed of the comparative example) when k=3, and 53.76 nanoseconds (134.16 times the speed of the comparative example) when k=4. As mentioned, nonlinear conversion in the exemplary embodiment was sufficiently higher in speed than the comparative example.

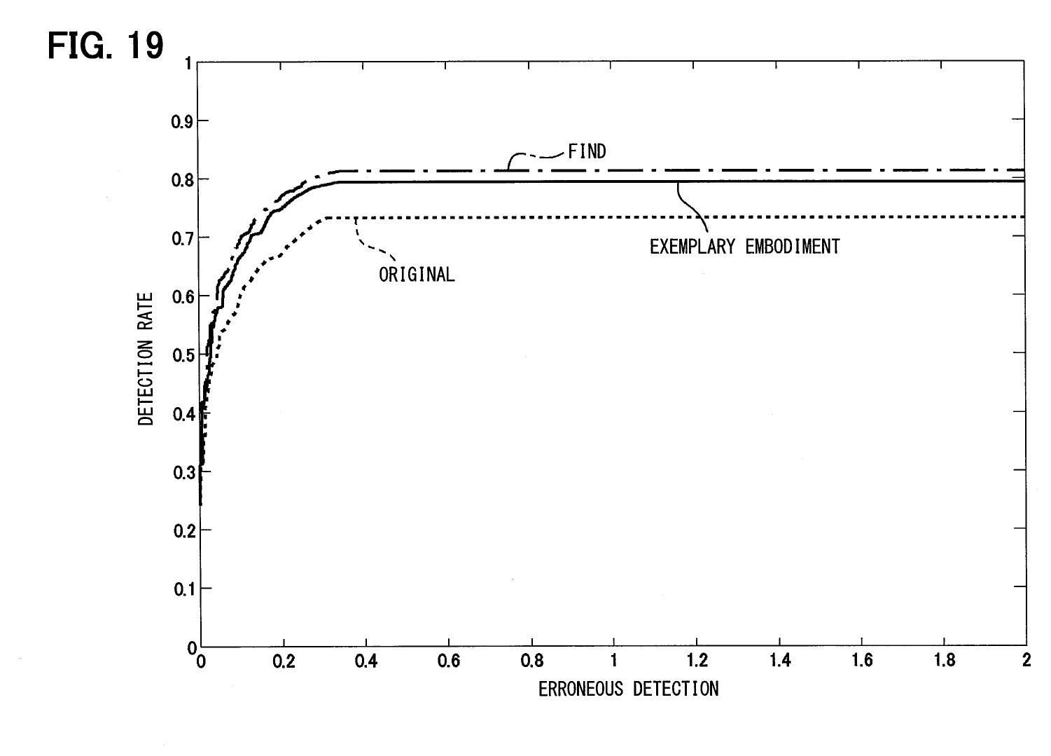

FIG. 19 is a graph illustrating erroneous detection-to-detection rate correspondence prevailing when a recognition model generated by learning is recognized by a recognition apparatus. The horizontal axis represents erroneous detection, and the vertical axis represents a detection rate. In the recognition apparatus, it is preferred that erroneous detection be infrequent, and that the detection rate be high. In other words, the graph of FIG. 19 indicates that a value nearest the upper left corner gives the highest recognition performance.

In FIG. 19, the broken line represents a case where a HOG feature amount originally implemented by Dalal is used as is to perform learning and recognition, the one-dot chain line represents a case where learning and recognition are performed by using a FIND feature amount that is obtained by optimally tuning the C parameter, and the solid line represents an exemplary embodiment. More specifically, the solid line represents a case where learning and recognition are performed by using a nonlinearly converted feature vector that is derived from the second embodiment of the present disclosure when k=4.

As is obvious from FIG. 19, using a FIND feature amount or the exemplary embodiment provides higher recognition performance than using a HOG feature amount as is. The exemplary embodiment uses a binarization scheme. Therefore, the exemplary embodiment is inferior in recognition performance to the FIND feature amount. However, the recognition performance of the exemplary embodiment is only slightly lower than that of the FIND feature amount. The above results verify that the embodiments of the present disclosure provide a considerably higher processing speed than the FIND feature amount and provide recognition performance substantially comparable to that of the FIND feature amount.

A further embodiment of the present disclosure will now be described. The present embodiment performs a cascade process to increase the speed of recognition that is achieved by a discriminator when a real feature amount is binarized with k different threshold values. [Expression 9] below represents a vector that is obtained when a real feature amount X is binarized with k different threshold values.

b=(b₁^{T},b₂^{T}, . . . ,bₖ^{T})^{T} [Expression 9]

For discrimination or other similar purposes, w^{T}b in [Expression 10] below is calculated to compare the result against a threshold value Th. In [Expression 10], w is a weight vector for discrimination.

w^{T}b=Σᵢ₌₁^{k}wᵢ^{T}bᵢ [Expression 10]

It is assumed, for example, that k=4, and that b₁, b₂, b₃, and b₄ are binarized at a 20% position, at a 40% position, at a 60% position, and at an 80% position, respectively. In this instance, b₂ and b₃ are obviously higher in entropy than b₁ and b₄. Therefore, w₂^{T}b₂ and w₃^{T}b₃ have a wider value distribution than wᵢ^{T}b₁ and w₄^{T}b₄.

In view of the above, the present embodiment calculates w₂^{T}b₂, w₃^{T}b₃, and w₄^{T}b₄ in the order named. If w^{T}b can be determined to be definitely greater or smaller than the threshold value Th in the middle of the sequence of calculations, the present embodiment brings the process to an immediate end. This results in an increase in the speed of processing. In short, cascading is performed in the order of the widest wᵢ^{T}bᵢ distribution to the narrowest or in the order of the highest entropy value to the lowest.

The present disclosure calculates co-occurring elements of an inputted feature vector by rearranging the inputted feature vector and performing a logical operation. Therefore, the co-occurring elements can be rapidly computed. The present disclosure is therefore useful, for example, as a feature amount conversion apparatus that converts a feature amount used for target recognition.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A feature amount conversion apparatus comprising:
a bit rearrangement portion that generates a plurality of rearranged bit strings by rearranging elements of an inputted feature vector being binary into diverse arrangements;
a logical operation portion that generates a plurality of logically-operated bit strings by performing a logical operation on the inputted feature vector and each of the rearranged bit strings; and
a feature integration portion that generates a nonlinearly converted feature vector by integrating the generated logically-operated bit strings.

2. The feature amount conversion apparatus according to claim 1, wherein
the feature integration portion further integrates the elements of the inputted feature vector as well as the generated logically-operated bit strings.

3. The feature amount conversion apparatus according to claim 1, wherein
the logical operation portion calculate the exclusive OR of the rearranged bit strings and the inputted feature vector.

4. The feature amount conversion apparatus according to claim 1, wherein
the bit rearrangement portion generates the rearranged bit strings by performing a rotate shift operation with no carry on the elements of the inputted feature vector.

5. The feature amount conversion apparatus according to claim 4, wherein
when the inputted feature vector is d-dimensional, d/2 bit rearrangement portions are provided.

6. The feature amount conversion apparatus according to claim 1, wherein
the bit rearrangement portion randomly rearranges the elements of the inputted feature vector.

7. The feature amount conversion apparatus according to claim 1, further comprising:
a plurality of binarization portions, each generating the feature vector being binary by binarizing an inputted real number feature vector; and
a plurality of co-occurring element generation portions respectively corresponding to the plurality of binarization portions,
wherein
each of the co-occurring element generation portions includes the plurality of the bit rearrangement portions and the plurality of the logical operation portions;
the feature vector of the binary value is inputted to the plurality of co-occurring element generation portions respectively from the plurality of corresponding binarization portions;
the feature integration portion generates the nonlinearly converted feature vector by integrating all the logically-operated bit strings generated respectively by the plurality of the logical operation portions in each of the co-occurring element generation portions.

8. The feature amount conversion apparatus according to claim 1, wherein
the feature vector being binary is acquired by binarizing a histograms of oriented gradients feature amount.

9. A feature amount conversion apparatus comprising:
a bit rearrangement portion that generates a rearranged bit string by rearranging elements of an inputted feature vector being binary;
a logical operation portion that generates a logically-operated bit string by performing a logical operation on the inputted feature vector and the rearranged bit string; and
a feature integration portion that generates a nonlinearly converted feature vector by integrating the elements of the feature vector and the generated logically-operated bit string.

10. A feature amount conversion apparatus comprising:
a plurality of bit rearrangement portions that generate a rearranged bit string by rearranging elements of an inputted feature vector being binary into diverse arrangements;
a logical operation portion that generates logically-operated bit strings by performing a logical operation on the rearranged bit strings generated by the bit rearrangement portions; and
a feature integration portion that generates a nonlinearly converted feature vector by integrating the elements of the feature vector and the generated logically-operated bit strings.

11. A feature amount conversion apparatus comprising:
a plurality of bit rearrangement portions that generate a rearranged bit string by rearranging elements of an inputted feature vector being binary into diverse arrangements;
a plurality of logical operation portions that generate logically-operated bit strings by performing a logical operation on the rearranged bit strings generated by the bit rearrangement portions; and
a feature integration portion that generates a nonlinearly converted feature vector by integrating the generated logically-operated bit strings.

12. A learning apparatus comprising:
a feature amount conversion apparatus according to claim 1; and
a learning portion that achieves learning by using the nonlinearly converted feature vector generated by the feature amount conversion apparatus.

13. A recognition apparatus comprising:
a feature amount conversion apparatus according to claim 1, and
a recognition portion that achieves recognition by using the nonlinearly converted feature vector generated by the feature amount conversion apparatus.

14. The recognition apparatus according to claim 13, wherein
the recognition portion
calculates the inner product of a weight vector in the recognition and the nonlinearly converted feature vector in the order of the largest distribution to the smallest or in the order of the highest entropy value to the lowest, and
terminates the calculation of the inner product when the inner product is determined to be greater or smaller than a predetermined threshold value for recognition.

15. A feature amount conversion program product stored in a non-transitory computer-readable medium, the program product including instructions causing a computer to function as a plurality of bit rearrangement portions, as a plurality of logical operation portions, and as a feature integration portion,
the bit rearrangement portions generating a rearranged bit string by rearranging elements of an inputted feature vector being binary into diverse arrangements,
the logical operation portions generating logically-operated bit strings by performing a logical operation on the inputted feature vector and each of the rearranged bit strings,
the feature integration portion generating a nonlinearly converted feature vector by integrating the generated logically-operated bit strings.
